(19) United States
(12) Patent Application Publication
(10) Pub. No.: US 2004/0036719 A1
(43) Pub. Date: Feb. 26, 2004

(54) Quicker development of database applications having a graphical user interface

(76) Inventor: George Michael Van Treeck, Alameda, CA (US)

Correspondence Address: George M. Van Treeck, 668 Westline Dr., Alameda, CA, 94501, US

(21) Appl. No.: 10/227,559

(22) Filed: Aug. 26, 2002

(51) Int. Cl. G09G 5/00

(52) U.S. Cl. 345/763; 345/826

(57) ABSTRACT

A visual, component-based construction method and apparatus combines the step of constructing the software of a graphical user interface, the step of defining the relational database, and the step of constructing the application logic of a software application into a single step, thereby shortening the time to develop a software application. The addition of a graphical user interface (GUI) component to a GUI container component and setting the property values of the added component constructs the software of a GUI, relational database and application logic of a computer software application in one step. State-based control flow between GUI forms of a software application is implemented by making each icon representing a component in a visual, component-based software development tool a type declaration keyword in a visual, object-oriented, logic programming language. In particular, icons representing types of GUI forms are declarations of types of activations and icons representing types of GUI form fields are declarations of types of variables. This visual, object-oriented, logic programming language has its own run-time control stack, control flow rules, declaration scope rules and variable name binding rules that are different from those of the language of the generated code, such as C++, Java, and the like.

### REFERENCES CITED

U.S. Pat. Documents

| | | | |
|---|---|---|---|
| 6314415 | November, 2001 | Mukherjee | 706/47 |
| 6247020 | June, 2001 | Minard | 707/954.1 |
| 6230318 | May, 2001 | Halstead, et al. | 707/108 |
| 6016394 | January, 2000 | Walker | 717/954 |
| 6014138 | January, 2000 | Cain, et al. | 345/826 |
| 6002867 | December, 1999 | Jazdzewski | 717/955 |
| 5913065 | June, 1999 | Faustini | 717/107 |
| 5850548 | December, 1998 | Williams | 717/107 |
| 5842020 | November, 1998 | Faustini | 717/111 |
| 5651108 | July, 1997 | Cain, et al. | 345/763 |
| 5537630 | July, 1996 | Berry, et al. | 345/763 |
| 5487141 | January, 1996 | Cain, et al. | 345/764 |
| 5423041 | June, 1995 | Burke | 717/117 |
| 5367619 | November, 1994 | Dipaolo, et al. | 717/107 |
| 5353401 | October, 1994 | Chigira | 717/107 |
| 5301313 | April, 1994 | Terada, et al. | 717/107 |
| 5206950 | April, 1993 | Geary, et al. | 717/109 |
| 4989132 | January, 1991 | Mellender, et al. | 717/139 |
| 4949253 | August, 1990 | Iizawa | 345/763 |
| 4949253 | December, 1988 | Huber | 707/1 |

### Other References

Microsoft Corp., User Guide: Microsoft Access, (1994)

Borland Software Corp., “Creating JavaBeans with BeansExpress”, Building Applications Version 6, Borland Software Corp., (2001), Chapter 2, pp. 1-24.

Burnett, M. M, et al., “FAR: An End-User Language to Support Cottage E-Services”, IEEE Symposia on Human-Centric Computing Languages and Environments, Stresa, Italy, September 2001. Pages 195 to 202.

Horstman C. S. et al., “JavaBeans.TM.”, Core Java Volume II—Advanced Features, The Sun Microsystems Press, (2000) Chapter 8, pp. 609-700.

Repenning, A., Ioannidou, A., “Behavior Processors: Layers between End-Users and Java Virtual Machines”, 1997 Proceedings of Visual Languages, Capri, Italy, September 1997.

Nilsson, U., Maluszynfski, J., Logic, Programming and Prolog, John Wiley & Sons, Ltd. (1995), 2cd ed., 101-108

Ladret, D. and Rueher, M., “VLP: A Visual Logic Programming Language”, Journal of Visual Languages and Computing (1991) 2, 163-188.

Pau L. F. and Olason H., “Visual Logic Programming”, Journal of Visual Languages and Computing (1991) 2, 3-15.

Ringwood , G., “Predicates and Pixels”, New Generation Computing, 7, (1989) pp. 59-700

Aho, A. V., Seti, R. and UlIman, J. D., Compilers Principles, Techniques and Tools, Addison-Wesley Publishing Company (1985), 1-511

### BACKGROUND OF THE INVENTION

1. Field of the Invention

The present invention relates to the development of computer application software that have a graphical forms-based user interface for querying and entering data in a database. More specifically, this invention relates to the steps of constructing the: graphical user interface (GUI) software, relational database, and application logic software of a software application.

2. Description of the Prior Art

Many software applications comprise GUI forms used for data query and data entry, a relational database, and application specific logic. The prior art requires that the software for GUI forms, relational database and application logic be constructed in three separate steps, each with their own set of development tools.

For example, software development tools (SDT) like Microsoft Access.RTM. from Microsoft Corporation first requires defining the database tables, using a table definition tool. Next, the GUI forms are defined by adding GUI components such as text, pictures, fields and buttons to a form component, using a form construction tool. And finally application logic via a query definition tool and programming via text editor is added. All software development products of the prior art use this paradigm.

The reason why GUI forms software and relational database tables are constructed in separate steps is because there is not a one-to-one correspondence of fields in a GUI form with fields in a table. For example, a relational database table may have fields that are not displayed in a form. A form may contain fields from more than one table. And, a table may have fields that are used in multiple forms.

Some parts of a software application's logic have been merged with the a GUI component. For example, a form field object may have properties specifying constraints such as data entered must be numeric and in a range of 0 to 99. The prior art also provides “calc” field components that perform statistical and arithmetic calculations on data in a database. And, the prior art provides buttons and menu items with built-in application logic, such as an “add” button that inserts form data into a database.

However, some application logic is constructed in a separate step from the construction of a GUI form because there is not a one-to-one correspondence of some logic to a single GUI form component. First, some application logic is computationally complex (for example, some financial, scientific and engineering calculations), where only a part of the calculations are displayed. Second, a form with fields from more than one table requires specifying a relationship between multiple tables (for example, a “left outer join” operation). And third, an application with more than one form requires specifying how the selections made in one form determines what information is accessible in another form (for example only showing certain email messages based on the user name entered in a previous form).

As a consequence, there are at least three types of software development tools: a tool for constructing GUI forms, a tool for constructing relational database tables, and a tool for constructing application logic. The prior art generally combines the three or more of tools into a package known as an integrated development environment (IDE).

The problem with three separate steps to develop a software application is that there is redundant work being done, which lengthens the development schedule. Application development would be quicker if one could define the fields in a GUI form, fields in a table, and application logic in the same step.

Another problem with three separate steps is that most people think in terms of “what” they want rather than “how” to get what they want. For example, a person naturally thinks in terms of “what” information they want to see and enter in the GUI forms (what the user of the application will see and interact with). People do not naturally think in terms of the underlying technology to make the application work properly. People don't naturally think about relational database issues such as how to normalize the database tables, which fields to specify as keys, the referential integrity constraints, which fields should be indexed, not-NULL, unique, etc. People do not naturally think in terms of the application logic, such as how to write the code to handle UI events, how to write the software to perform the database operations, how to write the error handling software, etc. As a consequence, most people lack the skills to create complex programs.

As components such as text, pictures, fields, buttons, menus and the like are added to a form, the form is displayed as it would appear when the application executes. This is known as WYSIWYG (What You See Is What You Get) development. Developing an application would be much easier if a software developer could specify “what” a user wants as a WYSIWYG GUI forms from which the table definitions and application logic would be generated automatically.

WYSIWYG specification of “what” a person wants in a GUI form is a mature art. For example, products such as Microsoft Access.TM. from Microsoft Corporation, dBase.TM. from Borland Software Corporation, R:Base.TM. from R:Base Technologies, and many other companies have SDTs that even nonprogrammers can quickly learn to use to construct GUI forms.

These SDTs provide a GUI menu or palette of GUI form components that can be selected to “visually” construct a GUI form. The concept of adding components together to construct software is known by such terms as “component-based construction”, “object-based construction”, and “object-composition.”

There are other component-based SDTs, which require the skill of a programmer to use. But, software with more capabilities can be created with these more powerful SDTs than is possible with the simpler SDTs. These more powerful SDTs use an object-oriented paradigm, where each component is a software object supporting class inheritance. Existing classes of components can be extended via inheritance to create new classes of components with new capabilities. Further, these new components can be added to the component palette of the SDT to extend the capability of the SDT.

The most well known example of true object-oriented GUI components are JavaBeans.TM. based on the JavaBeans specification from Sun Microsystems. Classes written in the Java.TM. programming language that adhere to the JavaBeans specification can be used in a component-based SDT to visually construct software. Examples of visual, component-based SDTs that use JavaBeans are JBuilder.TM. from Borland Software Corporation, VisualAge.TM. from IBM Corporation, VisualCafe.TM. from TogetherSoft, and the public domain netBeans SDT.

The object-oriented, component-based SDT also provides components, which are not GUI components. One common class of a non-GUI component is a table wrapper class, which is used to wrap an object-oriented programming interface around a relational database table. The table wrapper class has methods such as “find”, insert”, “update”, and “delete”. When these methods are called, the corresponding operation is performed on the wrapped table in the relational database by calling the corresponding operations in the relational database using programming interfaces to a relational database such as Open Database Connectivity (ODBC) and Java Database Connectivity (JDBC).

In the prior art, table wrapper objects are defined separately from GUI form objects because the wrapped table may have fields that are not displayed by the GUI form object; the form may contain fields from other tables as well; or the same table fields might be used in many forms.

To encourage reusability of developed components, the prior art of component-based SDT allows a software developer to create new components and easily add it to the component palette of the SDT. However, this is not practical for creating reusable GUI form components, for two reasons:

1) The prior art does not provide an implemented means to change the properties of each field that is part of a predefined GUI form selected from the palette of an SDT. The SDT only provides a property editor for the container's properties. There is no direct access to the properties of the components contained within a container object. To access contained components, a software developer must write their own property editor and add it to the SDT.

For example, one instance of a GUI form might have a “User Name” field that allows a user's name to be entered and another instance of that form where the “User Name” field is a display-only field. In the prior art, The software developer must write software to create a “field_properties” property which specifies the properties of each contained form field object and a custom property editor to edit the field_properties property. Thus, it is a lot more work to make a reusable GUI form than to use “copy-and-paste” of a form and edit the copies.

If a common property or component is changed in one form, then that change might have to be propagated to all the copies (such as adding a new database table field that must also be added to some forms). Thus, propagating changes in this manner is a tedious and time-consuming effort, particularly if the same table fields are used in more than one application.

2) The prior art does not provide a means to “visually” add text and pictures that appear before or between the fields of each instance of a predefined form. For example, a form for users to log into an application and a form for new users to create a new account may both have “User Name” and “Password” fields. However, the instructions displayed at the top of each form would be different.

The prior art of “visual” component-based SDT, would add the instructions to end of the component list, causing the instructions to be displayed after the “User Name” and “Password” fields. Next, the prior art requires the software developer to leave the visual, component-based SDT and use a text editor to edit the generated source code to specify that the added component be placed first in the display list.

For example, using JavaBeans in a Java IDE, a software developer leaves the “designer” used for visual, component-based construction, and goes into “source” view mode where the Java code generated by visual construction is edited with a text editor. Specifically, statements of the form “container.add(component, −1)” would change the “−1” (specifying addition after previously added components) to “0” (specifying it is the first component). Again, this extra work makes creating reusable GUI forms impractical (more work than creating a new form or using the copy-and-paste of a form followed by customizing each copy).

### BRIEF SUMMARY OF THE INVENTION

It is the object of the present invention to provide a means for people to shorten the time it takes to develop computer software applications by combining the step of creating the graphical user interface (GUI) software, the step of defining relational database tables and the step of constructing the application logic of a computer software application into a single step. Another object of this invention is to shorten the time it takes to develop computer software application by creating reusable GUI forms. Another object of this invention is to make software application development possible for people unskilled in the art of computer programming and relational databases by providing a simple visual, component-based construction of software applications without the need to write software in lower level, text-based languages (Java, C++, and the like).

This invention is a method and system for constructing a complete software application from the visual, component-based construction of the application's graphical user interface (GUI). The system of this invention is comprised of four components: 1) a computer system having a graphical user interface (GUI) display device, 2) a visual, component-based software development tool (SDT) to construct a software application; 3) a novel set of software classes described in more detail hereinafter; 4) each icon in the SDT representing a GUI component is also a component of a visual, object-oriented, logic programming language.

The first two components (computer system with GUI display and visual, component-based SDT) of this system already exist in the prior art and are well understood by those skilled in the art of software development. The third component of this system is a set of software classes, where each class is a combined GUI component class and also another class, such as a table wrapper class or logic application class. That is, each class serves more than one purpose.

The class inheritance diagram of FIG. 1 shows an abstract Form class 4, with the subclasses NavForm 6 and DataForm 7. An instance of the NavForm 6 class is a GUI form object (component) that does not contain fields for entering or displaying data (nor does it contain other Forms). A NavForm's primary use is for displaying text, pictures and navigational controls (such as buttons, menu items, and the like) that send the user to other forms.

A DataForm 7 is both a GUI form object and a relational database table wrapper object. As shown in FIG. 1, the DataForm class 7 has the two subclasses BaseForm 8 and GroupForm 9.

A BaseForm wraps a base table. An object in the BaseForm class 8 (in FIG. 1) contains at least one object of the DataField class 11, where each DataField is both a GUI field object and table field wrapper object. A method of this invention is that a BaseForm class can be extended to create a new subclass by adding DataFields defining a base table. The extended BaseForm is added to the component palette of the SDT as a “reusable” GUI form component.

This invention makes it practical to reuse such a form, by a BaseForm having a field_properties” property, which specifies application specific properties of each contained FormField within an extended BaseForm selected from the component palette. The BaseForm class has an associated field_properties property editor like that shown in FIG. 8 to make changing the application specific properties of contained FormFields a quick and easy process.

The Component class of the prior art from which all other classes of this invention inherit their properties and methods, is extended with a new property “desired_position”, which specifies the relative position the object should have when added to a container. The Container class of the prior art has the “add” method extended to make use of the desired_position property of each added component. This allows one to specify the display position of text, pictures, and the like anywhere within a Form that already contains components (without having to leave the visual, component-based SDT to use a text editor to specify the insertion position).

A GroupForm 9 (in FIG. 1) is both a GUI form object and derived table wrapper object. A GroupForm contains a group of other Forms. The GroupForm class has a property, which specifies the type of relational operation performed on the tables wrapped by the contained DataForms. The default relational operation is “join”.

The GroupForm class has properties specifying common columns used in the relational operation. The GroupForm class also has a Boolean “combined_layout” property, which specifies whether the contained Forms are combined into a single form or each contained Form displayed individually. Setting the combined_layout property to “true”, is a means of creating a form with fields corresponding to fields in multiple tables. Setting the combined_layout property to “false”, is a means of restricting access in one form based on selections in a previously displayed form. That is, when a field in a form is instantiated to a value and another form having a “common” field is then displayed, that common field restricts what data can be displayed and entered.

As with the prior art (shown in FIG. 2), this invention provides a Control class 205 with subclasses NavControl 206 and DbControl 209. NavControls provide buttons, menu items, and the like to display other forms. DbControls provide buttons, menu items, and the like to perform database operations such as find, insert, update and delete.

Also, as with the prior art (shown in FIG. 4), this invention provides a CalcField class for performing calculations on data and displaying the result in a form field. However, this calc field capability differs from the prior art in one important aspect. This calc field can be used to create complex calculations using visual component-based construction rather than reverting to a text editor to write software in a text-based programming language.

The GroupCalc class 403 (in FIG. 4), contains a group of calc fields. The GroupCalc class has the subclasses, IfCalc 404 and IfElseCalc 405, where the properties of the class specify a condition that must be satisfied before the group of contained calc fields can be executed. There are also several other subclasses of GroupCalc ( WhileCalc 406, DoUntilCalc 407, and ForCountCalc 408) that allow conditional tests and loop constructs, where the group of contained calc fields can be executed repeatedly while the properties of the class specifying a condition is satisfied. Because all calc fields inherit from FormField, they have a used_in_form property specifying whether the field used in a form (is displayed). This allows visual, component-based construction of complex calculations with only the final results of the calculation being displayed. In the prior art, such complex calculations were done via scripting or programming in a text editor.

A fourth component of this invention is that each GUI component is a syntactic component of a visual, object-oriented, logic programming language. Each icon corresponding to a component in the containment hierarchy of a program is a type declaration keyword in the language. Each label (specified by the name property of a component), is an identifier in the language. Each labeled icon representing a Form is an activation node in the activation tree of a program. Each labeled icon representing a FormField is a logic variable. This language has its own control stack, control flow rules, scope declaration rules, and variable name binding rules. FIGS. 9A and 9B show an example personal phone book application written in this visual, object-oriented, logic programming language.

### BRIEF DESCRIPTION OF THE DRAWINGS

The accompanying drawings, which are incorporated herein and form a part of the specification illustrate an embodiment of the present invention and together with the description serve to explain the principles of the invention. In the drawings:

FIG. 1 is a class inheritance diagram showing how the container classes of this invention inherit their properties and methods.

FIG. 2 is a class inheritance diagram showing how various types of components that are added to a container each inherit their properties and methods from the Component class.

FIG. 3 is a class inheritance diagram showing how various types of form fields each inherit their properties and methods from the FormField class.

FIG. 4 is a class inheritance diagram of various types of calculation fields.

FIG. 5 shows an embodiment of a “New . . . ” menu item that has a submenu (palette) of component classes, where a class can be selected to create a subclass extending the selected class.

FIG. 6 shows an embodiment of a component palette from which a software application developer can choose components for adding to a container. The figure also shows an example of an application container with components added from the component palette that comprise a visual logic program.

FIG. 7 shows an example of an added component that has been selected, which causes a property list editor to be displayed.

FIG. 8 shows an example of a property editor to change the display attributes of field objects contained within a form object.

FIG. 9A is the first part of an example visual, object-oriented, logic program listing that implements the account access forms of a personal phone book.

FIG. 9B is the second part of an example visual, object-oriented, logic program listing that implements the “Contacts” form of a personal phone book.

FIG. 10 is a context-free grammar (BNF) of a visual, object-oriented, logic programming language.

### GLOSSARY OF TERMS

Abstract class: A class representing an abstract concept, where instances of the class (software objects) have only some or no concrete implementation.

Abstraction: Representing the essential features without including background, inessential, or implementation detail.

Abstract method: A method of an abstract class not having an actual (concrete) implementation.

Activation: The run-time execution of a procedure (object method).

Activation record: Information needed to save the current execution state of a procedure (method) so that execution can continue in the procedure activation after returning from another procedure activation. An activation record is also known as a “frame” or “call frame”. The specific information in an activation record depends on the programming language and compiler (or interpreter) used, and typically comprises a returned value, actual parameters, saved machine status, local data, temporary values arising from evaluation of expressions, and some sometimes access links and control links.

Actual parameter: A value or reference to a value that an object method uses to instantiate the value of formal parameter of another object method.

Application logic: A set of rules or algorithm implemented in software that is applied to a specific use.

Base table: A table in a relational database that is not derived from a relational operation on other tables.

Block: A statement containing its own local data declarations.

Class: An abstraction of the common properties and methods common to all objects of a set. For example, all instances of the bird class (set all of birds) have the common properties: wings, feathers and beaks and a common method of bipedal walking.

Common column: A column of fields in a relational table that have the corresponding fields in the column of another table, such that the value of a field in one column of a table can be used to locate a row of data in one table by finding the corresponding value in the column of another table.

Component: A software object that is a component of a computer program.

Component-based: A method of construction or assembly, where a component (object) is added to a container component (object).

Component palette: A list of selectable components from a menu, which are used in component-based construction (see “Component-based”). Typically each component on the palette is represented by a selectable icon.

Concrete class: A class where all methods have been implemented (is executable).

Container: A subclass of components (software objects) which can contain other components, which are used in component-based construction (see “Component-based”).

Control flow: The sequence of procedure (method) activations.

Control stack: A run-time data structure to keep track of live procedure (method) activations. An activation record is pushed onto the stack when activation begins and is popped off when activation ends. The most recent activation node is on the top of the stack.

Derived table: A relational table derived from relational operations on other tables in a relational database (sometimes called a view table or a view). The basic relational operations are union, difference, Cartesian product, projection and restriction. Other relational operations such as intersection, join, outer join, etc. are derived from the basic relational operations.

Encapsulation: Restriction of access to the properties and methods of an object.

Foreign key: A table key (see Key) having a value used to locate a row in another (parent) table containing a column of primary keys for the purpose of relating the dependent row of data in a (child) table to a unique row of data in the parent table.

Formal parameter: A variable that is local to an object's method. And, that variable contains either a value or reference to a value, where that value or reference is specified by another object method.

Form: A graphical user interface based on the metaphor of a paper form containing fields displaying information and fields where a user of the form must enter data.

Form field: A graphical user interface component within a form, which is an area displaying data (a display-only field) or an area where a user of the form must enter data (a data entry field).

Graphical user interface: Pictures displayed by a software application running on computer system, where the user of the software application interacts with the displayed pictures to use the software application.

Implicit common column: A column of fields in a relational database having the same name and data type as another column of fields in another table.

Inheritance: The relationship between classes, where one class (the subclass) inherits some or all of the properties and methods of a more general class (the superclass).

Instance: A particular object or individual of a class (set) of objects. An instance of a named class is referred to by that same name. For example, an instance of the bird” class is called a “bird”.

Instantiate: Give a value to a variable that does not already have a value.

Key: One or more fields in the row of a table in a relational database that comprise a lookup value by which rows in the table are ordered.

Language: A means of communicating information comprising: an alphabet of symbols that are combined into tokens, a grammar defining the permitted context and arrangement of tokens in a sentence, and semantics defining the operational effect when translated and executed.

Logic programming language: A language based on a decidable (computable) formal logic, typically Horn clause logic or relational logic.

Message: A request for an object to carry out (execute the code of) one of its methods.

Method: A procedure or function which an object can perform.

Object: Anything that can be named and has “properties” and “methods”; an instance of a class having common properties and methods.

Object-based: A system that encapsulates both properties (data) and methods and enforces object identity.

Object identity: The rule that objects have unique identity throughout their existence.

Object-oriented: A system that is both object-based and class-based and allows messaging between objects.

Parent: A component that contains other components is called the parent of the contained components.

Primary key: A key (see Key) comprising a unique, non-NULL value used to locate a row of fields in a table.

Procedure: A set of steps to perform. If a procedure returns a result, then the procedure is also known as a function. In object-oriented terminology, a procedure is called a method.

Procedure definition: Associates a procedure identifier with a statement. The identifier is the procedure name. And the statement is the procedure body.

Programming language: Comprises a language (see the glossary definition of language) used to communicate instructions to a computer; a compiler that translates the language into a machine instructions; and a run-time environment in which the machine instructions execute to produce an intended operational effect.

Property: A value-based descriptor of an object (also known as an attribute or data member of an object).

Relational database: an object containing data stored in two dimensional arrays known as tables and containing metadata indicating the relationship between the tables.

Scope: The accessibility of an object's properties and methods to another method.

Subclass: A class inheriting some or all of the properties and methods of a more general class (a superclass).

Software application: A computer program that is applied to a specific use. For example, a word processing, spreadsheet calculations, payroll check generation, etc.

Superclass: A general class containing subclasses, where the subclasses have specialized properties and methods.

Variable: A name (identifier) representing an object holding a data value that can change, where each occurrence of the name in a program represents the same object (called name binding).

View: A relational table derived from relational operations on other relational tables (sometimes called a view table).

Visual: A system where a person manipulates objects (icons, fields, buttons and the like) in a graphical user interface rather than writing text-based commands and programs.

Visual programming language: A language (see the glossary definition of programming language) with an alphabet of visual components (icons, lines, etc.) and text properties (labels and property values), used to communicate instructions to a computer.

Wizard: A sequence of GUI forms which ask questions, provide GUI components to accept responses from a person, and perform actions based on the person's responses. The wizard is a means of leading a person through a set of complex steps required to create a desired result without the need for training.

### DETAILED DESCRIPTION OF THE INVENTION

This invention is a method and system that combines the step of constructing the graphical user interface (GUI) software, the step of defining relational database tables and the step of constructing the application logic of a computer software application into a single step, thereby shortening the time to develop a software application.

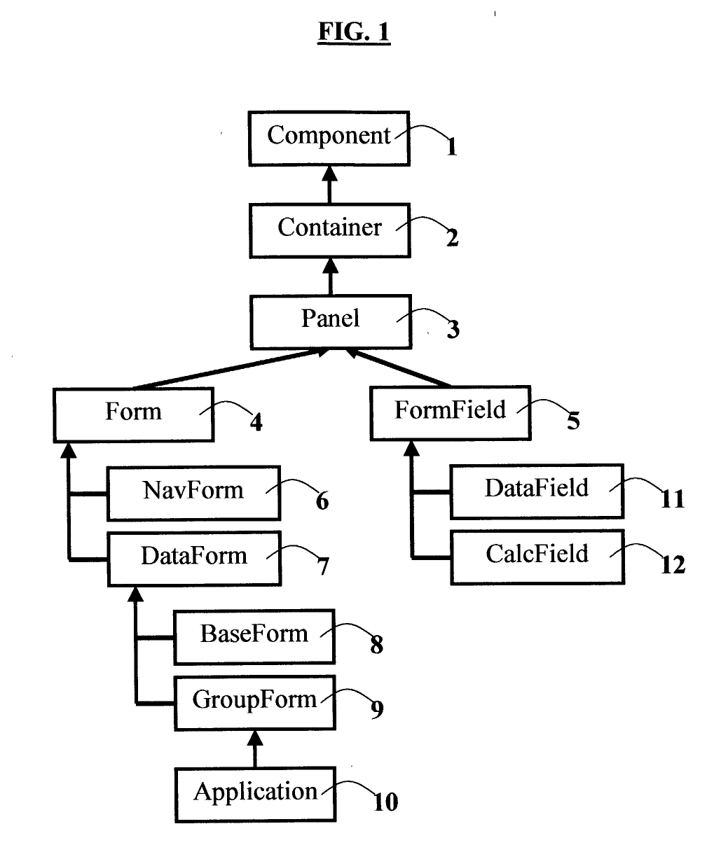

The following two naming conventions are used herein to make the detailed description more concise and easier to understand: First, an instance of a named class will be referred to by that same name. For example, an instance of the Component class 1 in FIG. 1 will be referred as a Component. Second, a graphical user interface (GUI) component will often be referred to by the class name of the software object that creates the GUI component. For example, instead of saying, “The user enter data into a GUI form field created and managed by a DataField . . . ”, this description uses the convention, “The user enters data into a DataField . . . ”, where DataField is a class that creates a GUI form field for accepting data input.

The preferred embodiment of the system of this invention is comprised of four components: 1) a computer system having a GUI display device, 2) a visual, component-based software development tool (SDT) to construct a software application; 3) a novel set of GUI component classes described in more detail hereinafter; 4) each icon in the SDT representing a GUI component is also a component of a visual, object-oriented, logic programming language.

Computer systems with GUI display devices, such as personal computers with a bitmapped display device, are used by millions of people and well understood in the prior art. The visual, component-based SDT is a software application that runs on the computer system. And the SDT is well understood by software developers in the prior art.

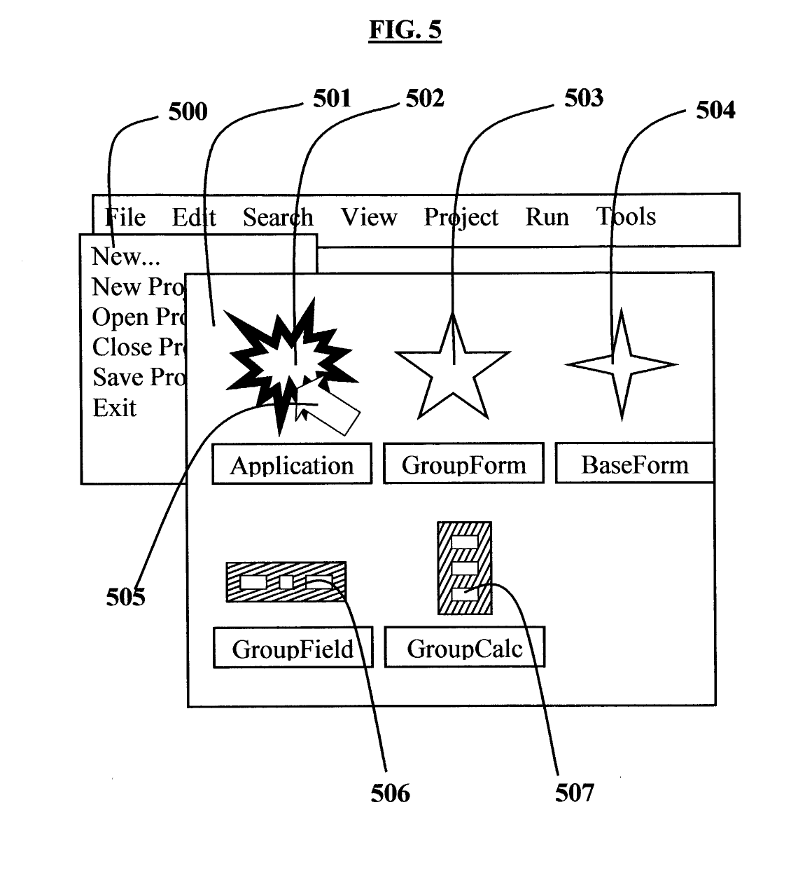

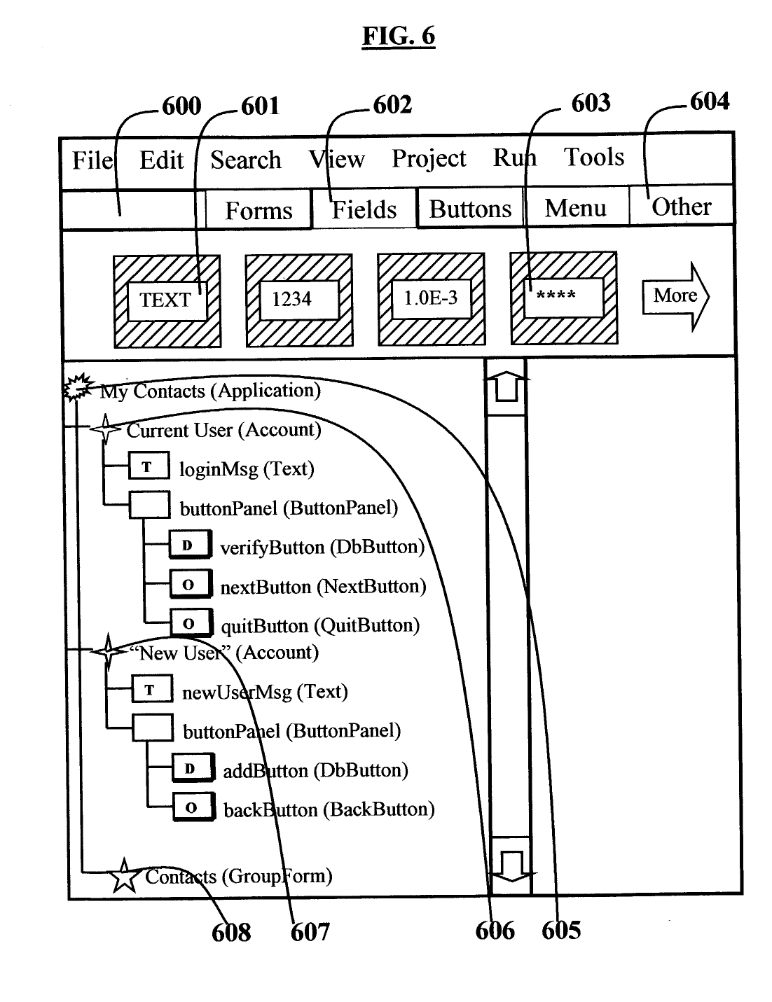

The following steps comprise the method for creating a software application using a SDT of the prior art, which is also used by this invention: As shown in FIG. 5, a software developer selects the “New . . . ” menu item 500 or a “New” button is selected, which displays a palette (menu) of GUI component classes. The software developer selects a class from the “New . . . ” palette to create a subclass of the selected class 502, by moving a cursor (505) and over the to-be selected class and using a device such as a button, key, or the like to indicate whatever is under the cursor should be selected. Typically, the selected class is a container class. From the component palette 600 (shown in FIG. 6), the software developer selects one or more components and adds them to the definition of the previously selected container class.

Because of the large number of components that could be used to construct a GUI, the component palette is often divided into subpalettes (submenus), each subpalette containing a subcategory of components that are located via tabs on the component palette 600, as shown in FIG. 6. For example, to select the text field component 601, the software developer first selects the “Fields” tab 602 on the component palette 600.

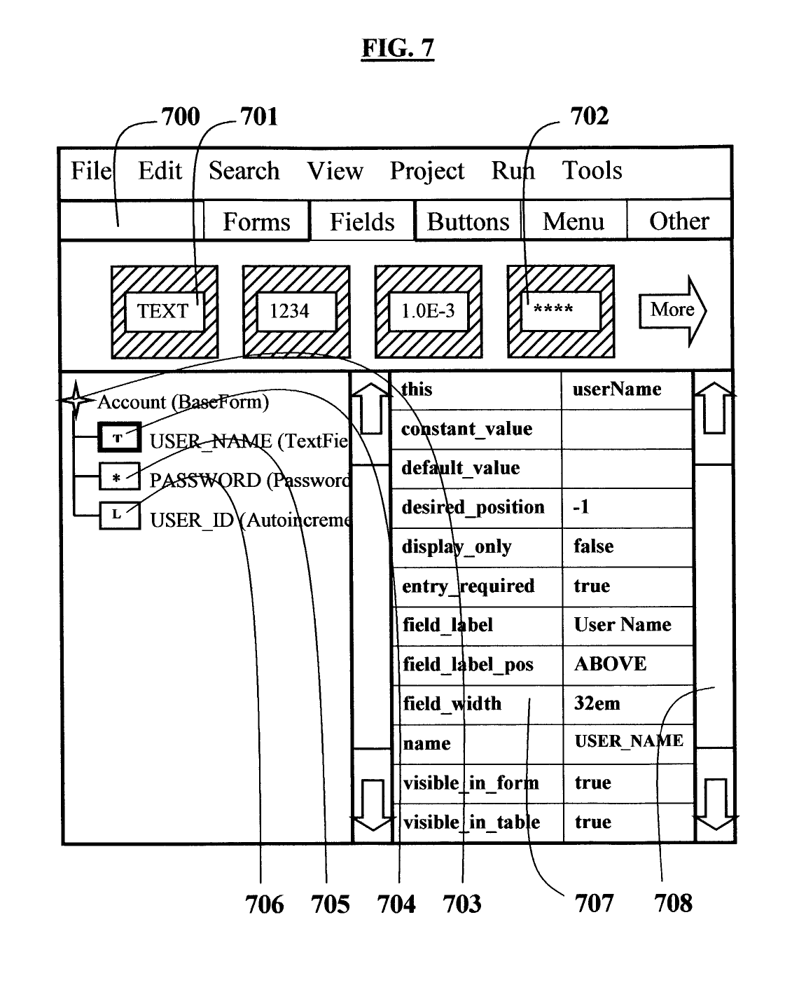

FIG. 5 shows the Application class 504 on the “New . . . ” component palette 500 being selected. FIG. 6 shows the “new” subclass, MyContacts 605 (with the name property set to “My Contacts”), which extends the selected Application class (505 in FIG. 5) and contains with many subcomponents. As shown in FIG. 7, the SDT provides a property editor 707 to specify the values of various properties such as, name, display size and display style, constraints, and desired behavior for each component (object) added to the program.

The means of constructing these classes of GUI component objects is well understood in the prior art. Also, the means of setting and getting the values of object properties is well understood in the prior art and varies with programming language (Java, C++, and the like) and the particular visual, component-based SDT used.

The third component of this system is a set of software classes, where each class is a combined GUI component class and also another class, such as a table wrapper class or logic application class. That is, each class serves more than one purpose. The component classes extend the prior art of GUI component classes as described hereinafter.

Every visual GUI component belongs to the abstract Component class 1 shown in FIG. 1. Each Component has the properties and methods of the prior art, which create a GUI component. The Component class has a “name” property that specifies a name that can be used to locate a Component.

The Component class has an abstract “display” method that provides a means for a Component to display itself in a GUI. Each concrete subclass of the Component class implements its own display method. For example, a text field component would display itself differently than a button component and respond to different events. The means of creating subclass-specific display methods is well understood in the prior art.

As shown in FIG. 1, the Component class 1 has a subclass, hereinafter referred to as the Container class 2, which contains other Components. Each Component, of the prior art has a “parent” property that references a Container, the parent, containing the Component. A Component uses the parent property to access the publicly accessible properties and methods of the parent. The Container class of the prior art extends the display method of the Component class to both display itself and also send a display message to each contained Component.

This invention extends the Component class of the prior art with a new integer property “desired_position”, which specifies the relative display order of a Component within a Container. Setting the desired_position property to 0 indicates the Component should be first in an ordered list; 1 implies second; etc. The default value is −1, indicating the Component should be displayed after the other Components that were added previous to the Component currently being added.

A component-based SDT of the prior art uses object introspection to determine the properties of an object and provides a property editor for all identified properties. Thus, the desired_position property will automatically appear in the property editor 707 of an SDT, as shown in FIG. 7. A software developer uses the property editor to set the desired_position property of an added component (if a position other than the default position is desired).

The Container class of the prior art has a concrete “add” method, which provides the means of adding Components to a Container by inserting an added Component into a vector of contained Components (an ordered display list). The add method of a Container also sets the parent property of the added Component to reference the Container.

This invention extends the “add” method of Container class of the prior art. The add method of this invention inserts the added Component into a vector of contained Components in the position specified by the desired_position property of the added Component.

The “add” method of the prior art (for example, the add method of the JavaBeans standard) is passed a parameter specifying the relative position of the to-be-added Component with respect other added Components. For predefined containers that already contain components, the prior art requires leaving the visual, component-based SDT and using a text editor to modify the parameter value passed to the “add” method to specify a non-default value. Specifically, statements of the form “container.add(component, −1)” would change the “−1” (which specifies adding after previously added components) to the value “0” (specifying that it is the first displayed component). This invention's desired position property and “add” method has the benefit of allowing the position to be specified from within a visual, component-based SDT instead of having to use a text editor, thereby saving some time.

An alternative embodiment is to create a subclass of the Component class of the prior art, where the subclass has the “desired_position” property, and also create a subclass of the Container class, where the subclass has the “add” method that uses the desired position property, and make all the components of this invention inherit from these new subclasses. The advantage of the alternative embodiment is that the Component and Container classes remain compatible with existing subclasses of the prior art that still require the prior art's means of specifying relative display position.

Most all visual, component-based SDTs of the prior art have the equivalent of a concrete “Panel” class 3 shown in FIG. 1, which is a Container class used to organize the visual layout in of those Components added to the Panel. The Panel class has a layout property that specifies how each contained component is visually positioned in a graphical display. Examples, of such layout are: a vertical column of displayed components, a horizontal column of components, a grid layout of components, X-Y coordinate layout, and the like.

This invention has the two subclasses of the Panel class 3, shown in FIG. 1, Form 4 and FormField 5. A Form is a software object that creates a GUI form, which displays itself and displays a collection contained Components. The Form class has an abstract “build” method, which is executed after all Form properties have been initialized and all Components added.

A FormField is a software object that creates a GUI form field. The two abstract subclasses of FormField 5 are DataField 11 and CalcField 12. The DataField class is a GUI field class and also a table column wrapper class. An alternative, view is that the DataField wraps a field in the row of a relational database table. The choice of viewing from the perspective of a field in a row or column is interchangeable.

The CalcField class is a GUI field class and also an application logic class that calculates and displays a value. The subclasses of CalcField have properties specifying the type of calculation and the operands of the calculation.

As shown in FIG. 1, the Form class 4 has the subclasses NavForm 6 and DataForm 7. A NavForm contains static content such as text and pictures and NavaControls (a class of objects that create GUI buttons, menu items and like that cause another Form to be displayed). A NavForm does not contain FormFields.

In FIG. 1, the DataForm subclass 7 of the previously described Form class 4 provides forms for data query and data entry. The DataForm class contains the previously mentioned FormFields 5 as well as static content such as text, pictures and the like and controls such as buttons, menu items and like.

The DataForm class is both a GUI form component class (has the properties and methods to create a GUI form) and a relational table wrapper class (has the properties and methods to wrap a relational table). Table wrapper classes are well understood in the prior art as a means of layering an object-oriented application programming interface (API) on top of the API of a relational database management system (RDBMS). The wrapper allows each table in a relational database to be treated as though it were an object in a software application (computer program).

A combined GUI form class and table wrapper class does not exist in prior art, because: a table may have fields that are not displayed in a form; a form may have fields from multiple tables; and a table may have fields used in multiple forms.

The DataForm class provides the following table wrapper properties and methods: The “table_name” property specifies the name of a relational table wrapped by that DataForm. The “data_fields” property comprises a vector of references to DataFields.

The abstract search methods, “findFirst” finds the first matching row, “findNext” finds the next matching row, “findprevious” finds the previous matching row, and “FindLast” finds the last matching row in the wrapped table with data matching any DataFields that are instantiated to values and instantiates any DataFields that were not previously instantiated to the found data.

The method “insert” inserts a row; “update” updates a row; and “delete” deletes a row in a wrapped table. The “commit” method commits a transaction to the database. The “rollback” method rolls back an uncommitted transaction.

The Boolean “find_first_on_entry” property of a DataForm specifies whether the DataForm's “findFirst” method should be used prior to displaying a DataForm.

Scope of a declaration is determined by the Boolean “uses_context” property of a DataForm. The uses_context property specifies whether the wrapped relational table and contained FormFields are accessible by the parent (container) of the DataForm. When the Boolean “uses_context” property is set to “true”, the wrapped table can be used in a relational operation and FormFields are accessible to the parent, and otherwise are not accessible. Also, because the data_fields property is a vector of references to the contained DataFields (a type of FormField), the data_fields property is also made accessible when the uses_context property is set to true.

The prior art has no equivalent to the uses_context property to specify accessibility to wrapped tables and fields for use in relational operations. In the prior art, tables, table columns and relational operations on tables are specified in a database modeling SDT rather than the visual, component-based SDT that specifies the GUI.

An alternative embodiment is for each FormField to have a uses_context property to be able to specify accessibility on selected FormFields rather than all FormFields contained in a DataForm.

The DataForm class also has an abstract “getDef” method, which returns the definition of a relational database table in a format compatible with the API of an RDBMS. The returned format can be a character string containing text in a language used by the RDBMS, such as SQL, XML, and the like, which would be used with an API such as ODBC, JDBC and the like. An alternative embodiment is that the returned definition be a complex data structure that can be used with a lower level API to an RDBMS.

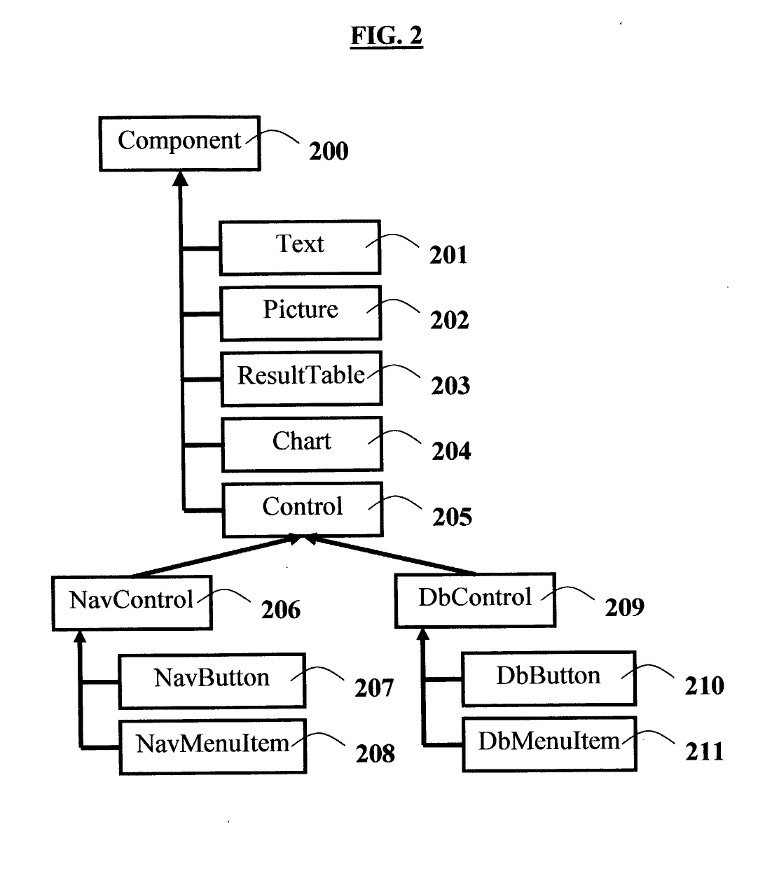

There are many non-DataField objects that can be added to a DataForm, examples of which are shown in FIG. 2 that are subclasses of Component 200. Text 201, Picture 202, ResultTable (displays the all rows satisfying the constraints of a database query), Chart 204 (displays a statistical summary of all rows satisfying the constraints of a database query). A Control 205 (button, menu item or the like) is always contained within a Form (anywhere in the containment hierarchy within a Form, such as within in a Panel and the Panel contained within a Form).

As shown in FIG. 2, NavControl 206 and DbControl 209 are two subclasses of Control 205. Subclasses of NavControl 206, such as NavButton 207 and NavMenultem 208, are GUI controls added to a Form for a user to navigate from a currently displayed Form to other Forms. That is, the NavControl sends a display message to another Form. Subclasses of DbControl 209, such as DbButton 209 and DbMenultem 211, are GUI controls for a user to perform database searches and data manipulation in a database. After performing the database operation, the DbControl sends a display message to a Form. Such controls are well understood in the prior art.

As described in FIG. 1, the BaseForm class 8 and GroupForm class 9 both are concrete subclasses of the DataForm class 7. A BaseForm is a container of FormField 5 objects and other GUI components (except Forms 4) and wraps a base table in the relational database. A BaseForm contains at least one DataField.

The FormField class has the following set of GUI component class properties, some of which are shown in the property list editor 707 of FIG. 7 (the rest made visible by using the scrollbar 708): the Boolean “used_in_form” property, which specifies whether a FormField creates a field in a GUI form; the Boolean “used_in_table” property, which specifies whether a FormField creates a field in a GUI table or chart; a “field_label” property that specifies the text in a label displayed near the form field (the field_label can be different than the FormField “name” property).

The FormField class has a “value” property, which references an object containing the data displayed and entered into a GUI form field. “The value of a FormField” refers to the value contained in the object referenced by the value property of the FormField.

The data type of the value contained in the object referenced by the value property is determined by the concrete subclass of the FormField class. An alternative embodiment is that a property can be used to specify the data type of the object referenced by the value property. For example an integer subclass of FormField might have a property specifying the type of integer field, such as long (64 bits), int (32 bits), short (16 bits), or byte (8 bits).

Each subclass of FormField also has subclass specific properties specifying the size and style of a FormField. For example a text field has a “width” property specifying how many characters can be displayed in a field. Whereas, a checkbox field would not have a character “width” property.

Each subclass of the FormField class extends the inherited display method to display itself and the field value in the object referenced by the value property only when the used_in_form property is has the value “true.” The display is specific to the data type of the contained value and subclass specific size and style attributes. Subclass-specific display methods are well understood in the prior art.

In FIG. 1, the FormField class 5 is shown inheriting from the container class, Panel 3. There are two reasons for inheriting from a Panel class. First, one might want to add other GUI components to a FormField. For example, one might add components such as a text label component, a search constraint component, a pop-up menu component, a help button component, and the like. Second, and most important, a FormField containing multiple FormFields allows component-based construction of composite fields. The GroupField and GroupCalc subclasses are used specifically to contain other FormFields and are described hereinafter in more detail. A form field component containing multiple subfields is unique to this invention.

The used_in_form property differs form the “visible” property of the Component class of the prior art. The “visible” property of the prior art is dynamic. That is, the visibility can be changed at run-time. For example, a field might be made visible when a particular menu option is selected by the user of a software application. A GUI component of the prior art does not serve a dual purpose (such as wrapping a table column). Thus, when a GUI component of the prior art is not visible, it servers no purpose.

In contrast to the prior art, the used_in_form property of this invention is static and does not change for the entire run-time of a software application. Even when used_in_form is set to “false”, the FormField still serves the purpose of either wrapping a table column (the DataField subclass) or defining a calculation (the CalcField subclass).

The used_in_form and used_in_table properties of FormField are application specific properties. Depending on the specific use of a form, a field from a table column may or may not be displayed.

The DataField class inherits all the properties of the FormField class and also has the following application specific properties: the “display_only” property specifies whether a GUI form field created by a DataField is used only for the purpose of the displaying data or also for the purpose of data entry by a user; the “entry_required” property specifies whether data must be entered into a GUI form field by the user of a software application prior to submitting the form field for processing; the “constant_value” property specifies an unchangeable value for the object referenced by the value property of a DataField, which has the side effect of setting the display_only property to true; the “default_value” property specifies a default value for the object referenced by the value property of a DataField used for the purpose of providing a data entry value when a user has not entered any data into the GUI form field created by the DataField; various properties that specify the position and style of the GUI field label. These properties and the means of implementing the behavior specified by the properties are well understood in the prior art.

The DataField class has the following table column wrapper properties: The “name” property inherited from the Component class specifies the column name of the wrapped table column (an API that provides an object-oriented interface to a table column), and is also used to locate a DataField within a BaseForm.

The Boolean “indexed” property specifies whether the wrapped column in a relational database table is indexed. The Boolean “primary_key” property specifies whether the wrapped table column is a column of primary keys. The “foreign_key” property specifies the referenced primary key column if the wrapped column is a column of foreign keys, and otherwise has an undefined value. Other properties specify such table column properties as referential constraints, whether each field in the wrapped table column must have a unique value, whether the fields in the table column may contain NULL values, and the like are also envisioned.

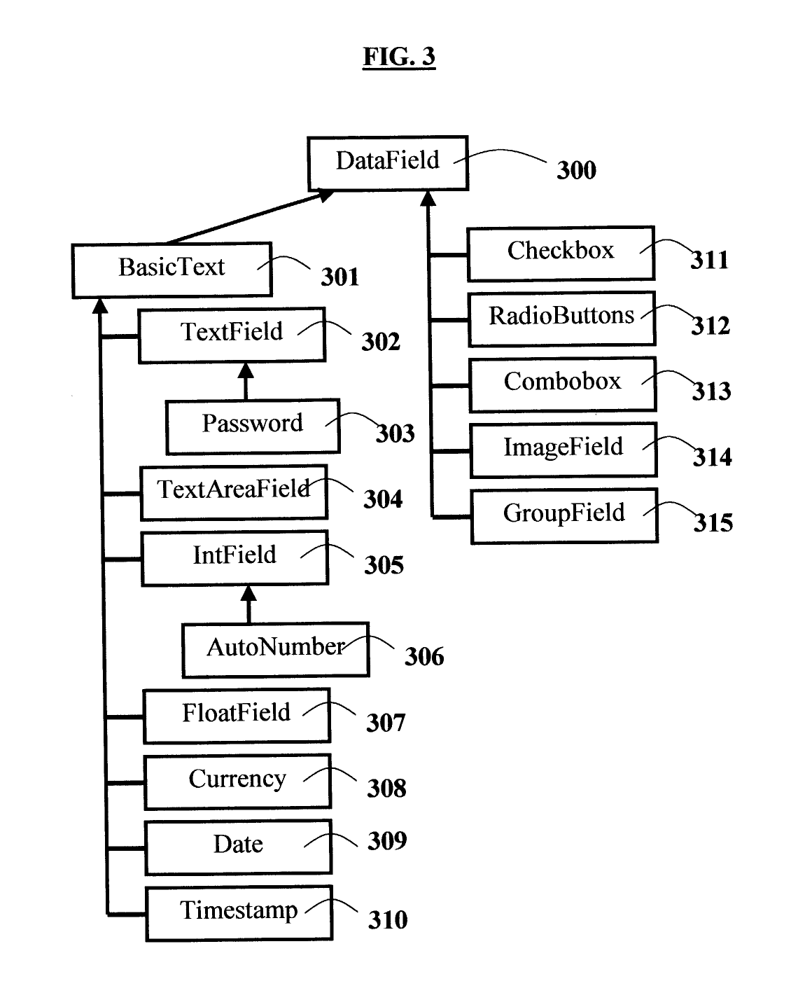

Each concrete subclass of the DataField class corresponds to a relational database table field data type. There are many possible subclasses of DataField 300 as shown in FIG. 3.

As shown in FIG. 3, there is a BasicText class 301, which has many subclasses whose values are displayed and entered as text strings, such as TextField 301 (a single line of text), Password 303 (a single line of text, where typed entries are masked), TextArea 304 (a multi-line text field), IntField 305 (integer value), AutoNumber 306 (automatically assigns a new integer value when a new row is inserted into a table), FloatField 307 (floating point value), Currency 308 (money values in country specific denominations), Date 309, and Timestamp 310 classes. Each subclass of DataField has properties specific to the subclass specifying data input constraints, such as the minimum and maximum values that can be entered. Implementing these text fields and associated constraint properties is well understood in the prior art.

Examples of non-text data types and corresponding fields are: Checkbox 311 (Boolean valued), Radio Buttons 312, Combobox (a menu list of choices) 313, ImageField 314 (displays a picture from the database), and GroupField 315 (contains a group of DataFields). It is obvious that many other subclasses of fields are possible such as fields for analog gauges, sound, video, and the like.

The DataField class also has a “getdef” method, which returns the definition of the wrapped table column in a format compatible with the API of an RDBMS. The returned format can be a character string containing text in a language used by the RDBMS, such as SQL, XML, and the like used with an API such as ODBC, JDBC and the like. An alternative embodiment is that the returned definition be a data structure that can be used with a lower level API to an RDBMS.

The DataField class of this invention is both a GUI field component class and a table column wrapper class. Some properties of the DataField specify GUI component characteristics and other properties define the properties of the wrapped table column. Adding a DataField to a BaseForm combines the step of constructing the software of a GUI form and the step of defming the corresponding column in a base table into a single step.

Microsoft Access.TM. and other products provide form field objects that are easily mapped to a table field. This DataField class and its subclasses differ from the prior art in two ways: The first difference is that a DataField's GUI form field doesn't just map to a column in an existing table in relational database. The BaseForm and DataFields also create the table and its columns at run-time (when the table and corresponding column does not already exist). Thus, adding a DataField to a BaseForm both constructs the software of a GUI form field and also defines the wrapped table column at the same time. The second difference is that the prior art uses two different tools, a table definition tool to define the table column and a form construction tool to define the GUI form field, whereas this invention only requires a single form construction tool.

The concrete subclass, GroupField 315 (in FIG. 3), is unique to this invention. A GroupField is a container of other DataFields. The GroupField is a software apparatus to provide visual, component-based construction of a group of fields that comprise a composite field (for example, the first name, middle initial, and last name of person together as single field), composite index (for example, indexing on the combined first name, middle initial, and last name together), and composite key (primary or foreign). If the relational database supports composite fields then the GroupField would wrap a composite field (single column) in the database. Otherwise, each contained field is a separate field (column) in the database.

A software developer uses the SDT to add DataFields to a GorupField and set the table column wrapper properties of the GroupField to specify if the GroupField is a composite field, index or constraint. The reason a field comparable to GroupField is not found in the prior art, is that defining composite fields, indexes and constraints is done in a separate step using a table definition tool rather than the form construction tool (visual, component-based SDT).

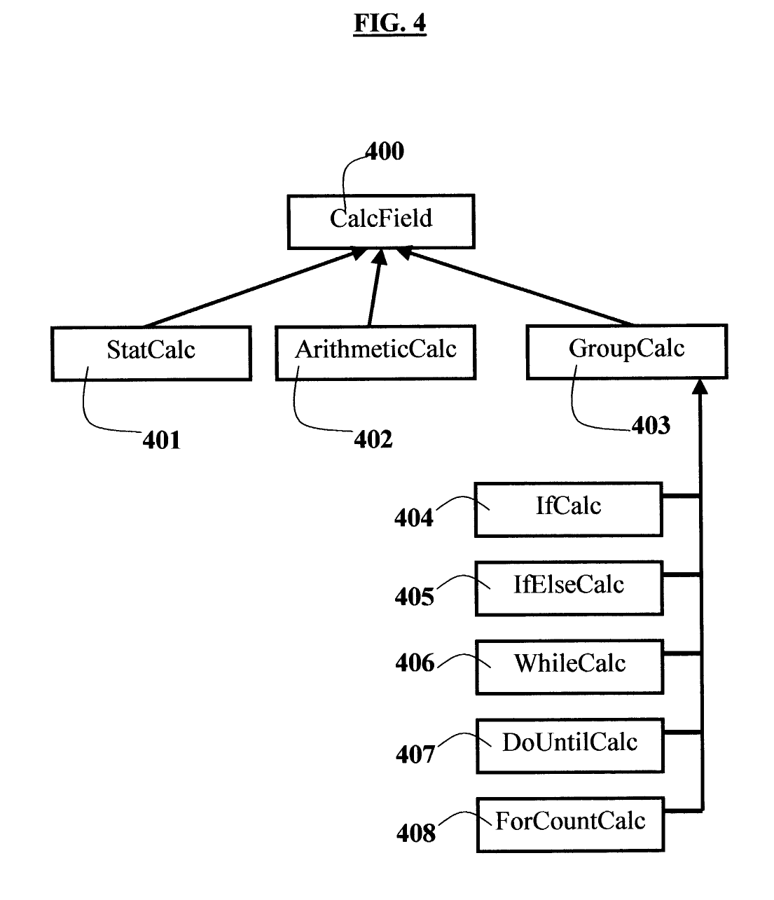

The other subclass of the FormField class is the CalcField class. Examples of typical calc fields in the prior art are the StatCalc 403 and ArithmeticCalc 404 shown in FIG. 4. The StatCalc field calculates a statistic on a DataField (table column), such as count, min, max, sum, mean, median, standard deviation, variance, and the like. The ArithmeticCalc field can perform operations such as addition, subtraction, multiplication, division, square root, power, log, sin, cos, and the like.

A CalcField performs a calculation and displays the result of the calculation in a GUI form field. The operands of the calculation and type of calculation are specified as object properties. When a CalcField is added to a DataForm (BaseForm or GroupForm), the CalcField uses the parent property to access the parent's contained fields as operands.

For example, form fields that show the subtotal charged for each purchase, the sales tax, and the total of the subtotal and tax would be embodied as: a StatCalc object with the name “Subtotal”, an “op” property set to “sum”, and an operand property set to a FormField named “Purchases”; an ArithmeticCalc object with the name “Tax”, an “op” property set to “multiply”, an operand_a property set to “Subtotal” and operand_b set to “0.085”; and another Arithmetic object with the name “Total”, an “op” property set to “sum”, an operand_a property set to “Subtotal”, an operand_b property to “Tax”.

The CalcField also has “common_field” property, which specifies another FormField as both having their value property referencing a common data object thus, when a CalcField sets the data object to the calculated value, it also sets the value of the common FormField. The common_field property is used to primarily to set the value of a DataField, when a software developer wishes to save the calculated value in a table.

However, the prior art lacks GUI components that can be used to visually construct more complex, application-specific logic that are not available as standard calc field components. For example, the SDT might not have a calc field for calculating mortgage payments, where only the final calculation of the mortgage is displayed. Thus, the prior art requires using a text editor to program in a language like Basic, C++ or Java rather than using GUI component-based construction of custom, complex, application logic.

This invention provides a means for constructing complex application logic using GUI component-based construction. In FIG. 1, an object in the CalcField class 12 is a subclass of FormField 5. The used_in_form and used_in_table properties inherited from the FormField class allow one to specify which components of a complex calculation are displayed.

The properties of a CalcField specify constant values and other FormFields as operands used in a calculation. Using other FormFields as operands provides a means for CalcField components can be chained together, where the result of one CalcField is an operand to another CalcField. This allows a software developer to visually select CalcFields from the component palette of the SDT and visually construct any calculation desired and only display the final result (via the used_in_form attribute of each CalcField).

Further, the GroupCalc class 403 and subclasses (404, 405, 406, 407, and 408) in FIG. 4 are unique to this invention. The GroupCalc class 403 inherits from CalcField 400 and is a class of objects that contain other FormFields. These calc fields allow a software developer to visually specify more complex, conditional calculations than is possible in the prior art of visual, component-based construction.

The value property of a GroupCalc references an object that contains the result of the contained group of calculations. This allows the GroupCalc field to be used as function, which returns a value that can used by other CalcFields. The “add” method of the GroupCalc (inherited from the Container class) is extended to set the used_in_form and used_in_table properties of each contained CalcField to “false.”

The GroupCalc class has an “arguments” property, which allows a software developer to specify which FormFields are used as operands in the calculations of the CalcFields contained within a GroupCalc. When a GroupCalc is on the “New . . . ” menu (labeled 507 in FIG. 5), it can be selected to create new subclass. When such a GroupCalc subclass containing CalcFields is compiled and added to the component palette, it becomes a reusable, custom calc field, where the arguments property is used as parameters to a procedure or function.

The following are subclasses of the GroupCalc class used for conditional and repeated execution. The IfCalc class 406 tests a condition specified by the Ifcalc object properties and executes the contained group of CalcFields 403. The IfElseCalc class 407 contains two GroupCalc fields 403. If the conditional test succeeds, then the first group of calc fields is calculated. If the conditional test fails, then the second group of calc fields is calculated. The WhileCalc object 406, calculates the contained group of calc fields while a condition is true. The DoUntilCalc object 407, calculates the contained group of calc fields until a condition is false. The ForCountCalc object 408, calculates the contained group of calc fields a specified number times.

The combination of used_in_form property inherited from the FormField class and grouping calculations together via visual, component-based construction provides a means for creating complex calculations. The prior art requires leaving the component-based SDT and using a text editor to write software in a scripting or programming language to create complex calculations.

The previously mentioned BaseForm class is hereinafter described in detail. The BaseForm class implements the “getDef” method inherited from DataForm, which returns a definition of the wrapped base table. This method is comprised of the step of first constructing the table definition header (for example, in SQL, “CREATE TABLE “+table_name+“{“, where “table_name” is specified by the “table_name” property inherited from the DataForm class), next each contained DataField is sent a “getdef” message and the returned column definition appended to the table definition, and finally a table definition delimiter added (for example, in SQL, “}“).

The BaseForm class extends the “build” method inherited from the Form class. The build method uses the “getdef” method to construct the definition of a base table. If a table having the name specified in the table_name property of the BaseForm does not already exist in a relational database, then the build method uses the RDBMS to create the defined base table in the relational database. This is implemented by using an interface to the database such as ODBC, JDBC or the like. If a base table of that name already exists, but does not have matching column definitions, then the build method signals a construction error using an error signaling mechanisms of the prior art such a throwing an exception. This build method is invoked as part of the run-time startup process of a software application after all BaseForm properties have been initialized and all components have been added to a BaseForm.

The BaseForm class extends the add method inherited from the Container class by also adding a reference to the added DataField to the vector of references comprising the data_fields property.

The BaseForm class implements the “reset” method inherited from the DataForm class, which resets the wrapped base table's cursor and for each contained DataField, uninstantiates the object referenced by the DataField's value property if it was instantiated to a value in the currently displayed BaseForm.

This invention makes it very easy and practical for a software developer to create reusable GUI form components. First, this invention provides the “field_properties” property of the BaseForm class, which specifies the application specific display properties of each contained DataField along with methods of “getting” and “setting” the field_properties property. Specifically, the BaseForm class has a “getFieldProperties” method which the scans of the vector of references to contained DataFields (the data_fields property) to obtain the application specific properties of each DataField and appends the property values to said field-properties property. And, the BaseForm class has a “setFieldProperties” method, which scans the values in the field-properties property and sets the properties of each corresponding DataField referenced by the data_fields vector.

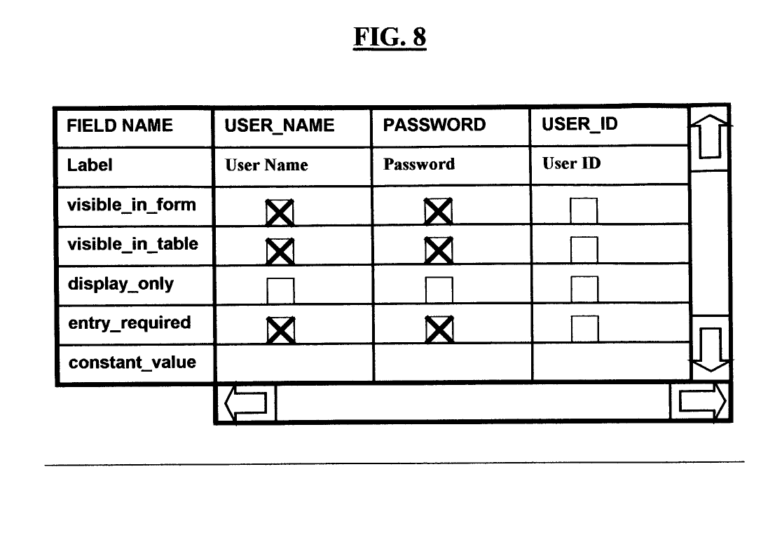

Second, this invention provides an editor like that shown in FIG. 8, to edit the field_properties property. The field_properties property editor is added to the SDT. Thus, when a software developer creates a new class extending the BaseForm class and adds an instance of the new class to the component palette of the SDT, the new component inherits the field_properties and field_propreties property editor of the BaseForm class.

The means of creating the field_properties property, access methods, and creating a property editor is well understood in the prior art. For example, using Java, the property editor would implement the “PropertyEditor” interface that is part of the JavaBeans standard. The editor uses the getFieldProperties method to populate the table property values shown in FIG. 8. And, the editor uses the setFieldProperties method to set the field_properties property.

However, creating this field_properties property and creating the associated property editor has not been done in the prior art because, because the prior art lacks an object which is both a GUI form and base table wrapper. The prior art implements reuse of a GUI form by copy-and-paste of GUI form and then adding or deleting GUI form fields as needed for a particular application.

The combination of the desired_position property inherited from the Component class and the “add” method inherited from the Container class allow the software developer to specify the position of an added object relative to DataFields that have already been added. The following six steps show how this invention is used.

First, as shown in FIG. 5, the software developer creates a new component that extends the BaseForm class by selecting the BaseForm component 502 on the “New . . . ” palette 500 of the SDT. The property editor of the SDT is used to assign the name, “Account”, to new class extending the BaseForm class.

Second, as shown in FIG. 7, form fields are selected from the component palette 700 and added to the Account component class 703 and form field properties set to values that the software developer wants to be the default for a reusable form of that type. For example, the default might be to set used_in_form to “true” for “User Name” and “Password” and set used_in_form to “false” for “User ID”. Examples of added form fields are labeled 704, 705, and 706 in FIG. 7. Both the GUI form and base table have been defined in this one step of adding DataField components to a BaseForm component.

Third, the new Account class is compiled and added to the component palette 600 of the SDT of FIG. 6, probably under the “Other” tab 604 of the component palette or a software developer defined tab. The prior art of SDT provide a means for the software developer to easily add new components to the component palette, such as a menu option like “add to palette . . . ” that invokes a “wizard” to assist the software developer in the process of adding a new component to the component palette.

Fourth, as shown in FIG. 6, instances of the Account class (606 and 607), were selected from the component palette and added to the Application subclass, MyContacts (with name property set to “My Contacts).

Fifth, the “field_properties” property editor like that shown in FIG. 8 is used to change the properties of one or more fields contained in each instance of Account (606 and 607).

Sixth, as shown in FIG. 6, other GUI components such a text, pictures and buttons are added to each instance of the Account components (605 and 607) and their desired_position properties set via the property editor of the SDT.

The prior art: lacks the desired_position attribute for all components, lacks the “add” method of the container class that makes use of the desired_position property, lacks a comparable used_in_form property of a form field, lacks a GUI form component with a field_properties property and associated property editor, and lacks a class that implements both a GUI form and base table wrapper object. Thus, the prior art lacks the ability to use a visual, component-based SDT to define a form class that also defines a table and then reuse instances of that form class, each instance potentially displaying different fields of the corresponding base table and displaying application specific text, pictures, buttons and the like in the proper position.

The BaseForm class was described hereinbefore. The other subclass of DataForm 7 is GroupForm 9, shown in FIG. 1. A GroupForm contains of a group of Forms (at least one Form). A GroupForm has the properties and methods to create a GUI form and the properties and methods to wrap a derived relational table. A GroupForm corresponds to a table derived from a relational operation on those tables wrapped by those DataForms having a uses_context property value of “true.”

By definition of a relational database, the result of a relational operation on a set of relational tables in always another relational table containing columns from the related tables. Therefore, a relational operation performed by a GroupForm on the tables wrapped by the contained DataForms creates a derived relational table containing fields (DataFields from the wrapped tables). A table derived from a relational operation on other tables is also known in the art as a “view” or “view table”.

The GroupForm class has a “data_forms” property comprised of a vector of references to zero or more contained DataForms. The GroupForm class extends the “add” method inherited from the Container class by also appending each added DataForm having its uses_context property set to true to the vector comprising the data_forms property.

The group_relation property specifies the type of the relational operation applied on those tables wrapped by those contained DataForms having their uses_context property set to “true”. The relational operations specified by the group_relation property are standard relational operations: restriction, union, intersection, difference, product, join (inner join), left outer join, right outer join, full outer join, and the like. “join” is the default group_relation property value.

The Boolean property, uses_implicit_common_columns, of the GroupForm class specifies whether implicit common columns are used in the relational operation on those tables wrapped by the contained DataForms having a uses_context property set to “true.” Implicit common columns are those table columns having the same name and same data type are used as common columns. For example, two integer columns having the name “ID” would be used as common columns. Implicit common columns are well understood in the prior art.

The “explicit_common_columns” property of the GroupForm class explicitly lists the names of those table columns to be used as common columns in the relational operation on those tables wrapped by the contained DataForms having a uses_context” property set to “true”. For example, “ID=EMPID” explicitly specifies that the table column named “ID” is common with table column named “EMPID”.

When the Boolean combined_layout property of the GroupForm class is set to “true”, then it specifies that, at runtime, the forms contained within the GroupForm are combined and displayed as a single GUI form. If the combined_layout property has the value, “false”, then each contained Form is displayed individually (analogous to a stack of playing cards displayed one at time) and the relational operation (group_relation) is always a join operation. That is, setting the combined_layout property to “false” has the side effect of also setting the group_relation property to the “join” operation type. The default value of the combined_layout property is “true”.

When the combined_layout property has the value, “true”, and the RDBMS provides views, then the preferred embodiment is that, at run-time, the derived table is created as a view in a relational database. If the RDBMS does not provide views, then the embodiment is the construction of a derived table by constructing a query, and using the specified group_relation, table names from the wrapped tables of the contained DataForms, and specified common columns, querying the RDBMS, and using the returned result-set as the derived table. Constructing the definition of a derived table is described in more detail as part of the “getdef” and “build” methods of this GroupForm class. The methods of creating views and result-sets is well understood by all competent software developers using relational databases.

When the combined_layout property has the value, “false”, then the embodiment is, at run-time, a “stepwise” derived table, where each separately displayed DataForm within a GroupForm shows a piece (some of the fields) of the (derived) join table. The join operation is computed and displayed incrementally, where a row selected from the table wrapped by a previously displayed DataForm is used as the first operand of the join operation to locate and display fields from a row in the table wrapped by a currently displayed DataForm. This stepwise join operation is used by all Prolog language run-time environments, and thus the implementation of this well understood by developers of Prolog compilers.

An alternative embodiment to the “combined_layout” property of the GroupForm class is to have two subclasses of GroupForm, a CombinedForm and FormSet class. The CombinedForm would display all contained Forms as a single, combined form. And the FormSet would display each contained Form individually.

The GroupForm class implements the reset method inherited from the DataForm class by resetting said wrapped derived table's cursor and sending a reset message to each contained Form.

The “build” method of the GroupForm has a data_fields initialization method, which creates a vector of references to DataFields comprising the data_fields property inherited from the DataForm class using the following scope declaration method: For each DataForm referenced by the data_forms property of a GroupForm (those DataForms having a uses_context property value of “true”), each reference to a DataField contained in the data_fields property of each DataForm is appended to the data_fields property of the GroupForm.

The build method of the GroupForm class also comprises a duplicate removal method, which removes references to duplicate DataFields from the data_fields vector property, where a duplicate DataField is a DataField with a value property referencing the same data object referenced by another DataField value property.

Also, the duplicate removal method sets the “used_in_form” property of each duplicate DataField to the Boolean value, “false”. This saves the software developer time by not having to use a property editor to explicitly turn off the visibility of duplicate fields in a form.

The GroupForm class implements the “getdef” method inherited from DataForm, which returns the definition of a derived table (view or result-set). When the RDBMS provides the capability of creating “views” then, the first step of this method is comprised of constructing the view definition header (for example, in SQL, “CREATE VIEW table_name AS SELECT “, where “table_name” is specified by the “table_name” property inherited from the DataForm class). Otherwise, a simple “SELECT” query header is constructed as the start of SQL query returning a resultset.

Next, each DataField referenced by the data_fields property has its field name appended forming list of field (column) names, which specifies the columns of the derived table. Next, each DataForm referenced by the data_fields property has its table_name property value appended, followed by appending the relational operation specified by the group_relation property, and finally appending a list of common columns, where the common columns are specified by the uses_implicit_common_columns and explicit_common_columns properties of the GroupField and by the primary and foreign key properties of the DataFields referenced by the data_fields property.

The build method checks the value of the combined_layout property. When the combined_layout property has the value, “true”, and the kDBMS allows creation of views, then the build method uses the getDef method to construct the definition of a view. If a view having the name specified by the table_name property of a GroupForm does not already exist in a relational database, then it creates the defined view in the relational database. This is done by using an interface to the database such as ODBC, JDBC and the like. If a view of that name already exists, but does not have a matching definition, then the build method signals an error using the error signaling mechanisms of the prior art such a throwing an exception. If the RDBMS does not allow creation of views, then the getDef method returns a database query which is then sent to the RDBMS. The returned query result-set is the derived table.

An envisioned optimization is that a parent (outermost) GroupForm having a combined_layout value of “true”, would construct a single, combined view (or single combined query result-set), rather than having each contained GroupForm creating a view (or result-set).

In the prior art, visually constructing the software of a GUI form can not define a table derived from a relational operation on multiple tables, because the GUI components added to a form of the prior art are not also table wrappers. In the prior art, a derived table (a view or result-set) is defined in a separate step with a database or query definition tool, rather than the tool used to visually construct GUI forms software. The properties and methods of the DataField, BaseForm and GroupForm classes provide a means for combining the step of constructing the software of GUI forms and the step of defining the relational operation on tables (application logic) into a single step.

The prior art packages four types of application logic (rules and actions) into components on the component palette of an SDT: 1) field value constraints for data entry and searching, which can be expressed as field properties; 2) GUI “calc field” components are commonly used calculations that set a field to a calculated value, where field properties define the type of calculation and operands; 3) a GUI control component such as a button or menu with properties specifying common database operations like “find first”, “find next”, “find previous”, “find last”, “insert”, “update”, and “delete”; 4) a GUI control component such as a button or menu item with properties specifying the name of the next form to display.

However, the application logic (rules and actions) not provided by the prior art as components on the component palette of an SDT specify how control flows based on state. For example, data selected by a software application user in one GUI form sets a state determining what information is displayed in another GUI form and which GUI forms can be displayed next. In the prior art, this requires using either a text editing tool to write code implementing this application logic or using a tool to create database queries rather than using the visual, component-based tool used to construct GUI forms.

This state-based control flow requires a programming language having a syntax representing an activation node in the activation tree of a program (typically called a procedure, function or method in text-based languages like Pascal, C, C++, Java, etc.), control flow rules and a run-time control stack. Further, state-based control flow requires a syntax component representing a variable (a data object that contains a value, where the value specifies the state), with variable declaration scope rules and variable name binding rules.

Specifically, the prior art lacks a icon on the component palette of a visual, component-based SDT (where the icon represents a software object with the properties and methods of a GUI component) that also corresponds to a procedure (method) activation with declaration scope rules, control flow rules, and run-time control stack. And, the prior art lacks a icon (component) on the component palette of a component-based SDT that corresponds to a variable in a programming language with declaration scope and name binding rules.

The fourth component of this invention solves this deficiency by providing a visual, object-oriented, logic programming language having the syntax and semantics of activations and variables. Each icon representing a selectable Component on the component palette of a visual, component-based SDT is a type declaration keyword in the language. Specifically, each icon representing an instance of the Form class in a program declares a type of activation (analogous to the “PROCEDURE” and “FUNCTION” keywords in the programming languages Pascal, Modula, and the like). And each icon in a program representing an instance of the FormField class declares a type of variable in the language. All other selectable icons declare the type of a constant value or type of action within an activation.

The text label on an icon in a program (identifier) is specified by the name property of the software object (component) represented by the labeled icon, where value of name property (and icon label) is set by the software developer. Thus, the labeled icons representing Forms in the containment hierarchy of a program are named activations (analogous to the software developer specified name of a procedure or function in many programming languages). And labeled icons representing FormFields in the containment hierarchy of a program are named variables. In the prior art, the icon label is the name of the corresponding object, rather than the name specified by the name property of an object (component).

A shown in FIG. 1, the Form class 4 inherits the properties and methods of GUI component (Component class 1). The Form class also comprises properties and methods providing the control stack and control flow rules of a run-time language environment.

The Form class has a “control_stack” property, which contains activation records for each Form traversed to reach the currently displayed Form. The activation record of the currently displayed Form is on the top of the control stack. This control stack is the control stack of the run-time environment of a visual, object-oriented, logic programming language.

When a Form displays itself, the Form's display method pushes a corresponding activation record (sometimes called a frame or call frame) onto the control stack, where each activation record contains a reference to the displayed Form.

The Form class has a “build” method, which is used to send an initialization message to all contained Components and then initializes itself. The build method has a parameter which references the run-time control stack, which the build method uses to set the control_stack property. This build method is extended by the BaseForm and GroupForm subclasses.

The Form class also has an integer “form_position” property that specifies the relative position of a Form with respect to other Forms within a container. This form_position property differs from the inherited desired_position property of the Component class in two respects: First, form_position specifies a position relative only to other contained Forms. Whereas, desired_position specifies position relative all contained Components (including Forms). Second, form_position is used only for control flow. Whereas, desired_position specifies the relative display position within a displayed Container.

The Form class has an abstract “reset” method, which resets the state of the Form referenced by the activation record on top of the control stack back to the state when that Form was first displayed. The subclass, DataForm, extends the abstract reset method inherited from the Form class. The abstract DataForm reset method resets the cursor of a wrapped table and resets each contained FormField's value property to those values of the time when the DataForm was first displayed.

The Form class has an “unwind” method. The Form referenced by the activation record on top of the control stack performs a stack unwind by first using its “reset” method and next, pops the activation record from the control stack. The unwind method returns the reference to the Form that is referenced by the popped activation record. Form subclasses may extend the unwind method.

The Form class has a “resume” method to resume control in a previous activation which uses the “reset” method and then redisplays the Form referenced by the activation record on top of the control stack without creating a new activation record. The resume method is used after unwinding the control stack.

The Form class has the following control flow methods: a “gotoNext_form” method; a “gotoPrior_form” method; and the “gotoNamed_form” method.

The gotoNext_form method sends a display message to the next in order Form, where the next in order Form is located by: the currently displayed Form sending a message to its parent to display the next in order Form, passing its form_position property value as a parameter. If the parent does not contain a next in order Form, then the parent sends a message to its parent to display the next in order Form, passing its own form_position property value as a parameter. This process of searching up the container hierarchy repeats until a next in order Form is located and the located Form is sent a message to display itself

The gotoPrior_form method “backtracks” to the previously displayed Form (returns control to the previous activation), by first using the “unwind” method and next using the “resume” method.

The gotoNamed_form method, takes a parameter specifying the name of the Form to locate and display (activate). A named Form is located and activated in the following method: The control stack is searched for the named Form. If an activation record referencing the named Form is found on the control stack, then the “unwind” method is used repeatedly until the activation record referencing the named Form is on top of the control stack, and next the “resume” method is used. If an activation record referencing the named Form is not found on the control stack, then the named Form is located by using the parent property of the currently displayed Form to message the parent to locate the named Form. If the named Form is not located within the Forms contained by the parent, then the parent uses its parent property (grandparent) to locate the named Form. This process of searching up the containment hierarchy to locate the named Form repeats until the named Form is found and a display message sent to the named Form.

The GroupForm class (a subclass of the Form class) has an additional control flow rule. The display method inherited from the Container class is extended to implement the following control flow method: If the combined layout property of a GroupForm has the value “true”, then a single, combined GUI form is displayed (activated) and a corresponding, single activation record is pushed onto the run-time control stack. Otherwise, the first contained Form within the GroupForm is sent a display message.

The “build” method of the GroupForm class extends the build method inherited from the Form class. After assigning the control_stack property to the reference passed as a parameter to the build message, the build method of the GroupForm class also sends a build message to each contained Form, passing the reference to control stack as a parameter to each build message.

As shown in FIG. 1, the Application class 10 is a subclass of GroupForm 7. The Application object is the outermost container of a software application. The combined_layout property of an Application class always has the value of “false” (is a constant value). The build method of the Application class extends the build method of the GroupForm class, by creating a new control stack and assigning the control_stack property to reference the control stack prior to invoking the build method of its superclass (the GroupForm class). The initial display message is sent to the Application by the language-provided run-time environment that initializes and starts an application. This run-time environment initialization is implemented as part of the startup code of the Application class (the equivalent of the “main” procedure in a language like Java, C++, C and the like).

Once a Form is displayed, then control flow is determined by user interaction with the GUI controls (instances of the Control class 205 shown in FIG. 2) such as buttons, menu items, and the like contained within that displayed Form.

These GUI controls cause the currently displayed Form to activate (display) another Form. As shown in FIG. 2, the two primary subclasses of the Control class 205 are the NavControl 206 and DbControl 209 classes. The NavButton class 207 has a target_form property specifying name of a Form to display when a button is selected. The NavMenultem class 208 has a target_form_options property specifying a list of Form names, of which the selected Form is displayed.

The DbControl class 209 has the “form_on_success” and “form_on_failure” properties specifying the name of the form to display when the attempted database operation succeeds or fails.

A Control uses its parent property to locate the Form containing the Control. If the name of the specified destination Form in a Control is “Next”, then a “gotoNext_form” message is sent to the parent Form. If the name of the specified destination Form in a Control is “Back”, then a “gotoPrior_form” message is sent to the parent Form. When the name of the Form to display is specified, then a “gotoNamed_form” message is sent to the parent Form, with specified name passed as a parameter. When the name of the Form to display is not specified, then a “reset” message is sent to the parent Form (the operational effect being a “backtrack” to the current Form).

The “value” of a FormField (variable) is the value stored in the data object referenced by the value property of a FormField. The FormField subclass (or subclass property) defines the data type of a variable (the type of data held in the data object). The name of a variable (FormField) is the value of the name property inherited from the Component class.

Scope of declaration for variables is specified by the uses_context property of the DataForm class, where the scope of variable is the same as the scope of a FormField. If a contained DataForm's uses_context property has the Boolean value, “true”, then the parent can access the FormFields within that DataForm (public access). Otherwise, the FormFields are private to the contained DataForm.

Variable name binding is provided by the GroupForm class. The “build” method of the GroupForm class uses the following variable name binding method: Each DataField referenced by the data_fields vector property is checked to determine if the DataField corresponds to a primary key or foreign key in a table. All DataFields wrapping common columns as identified by the primary key and foreign key constraints are “bound” (have their value properties set to reference the same data object). Next, if the uses_implicit_common_columns property has the value, “true”, then DataFields having the same name (name property has the same value) and are of the same subclass (field has the same data type), then they are common columns and bound. And if the explicit_common_columns property specifies two DataFields are common, then they are bound.

An example of using the name binding of variables is where the user of a software application selects a product category in a form, which sets a “context” that is “used” by another form to display a list of products belonging to the previously selected product category. This is embodied as a DataField contained in a “Product Categories” DataForm and another DataField contained in a “Products” DataForm both being references to the same value. Setting the value of the DataField in the “Product Categories” DataForm also sets the value of the DataField in the “Products” DataForm. This value then restricts what products are displayed in the “Products” form.

Another example of name binding is where a CalcField is used to calculate the total price charged of products ordered by a customer and instantiating a DataField to that value (to store the total price charged in the database). In this case, one would make the CalcField a common field with a DataField via the common_field property of the CalcField.

The prior art lacks a component on the component palette that corresponds to a variable in a programming language, because there is no name bindings semantics in the prior art. In the prior art, each added component is assigned a unique name (required for object identity in the code generated by the SDT). The prior art lacks rules that automatically “bind” FormFields (variables) to reference the same data object.

Variables (FormFields) in this language are “logic variables” and are not “assigned” values. Rather, logic variables are “instantiated” to a value via unification (unification is well understood by Prolog compiler developers). Instantiation of a FormField to a value is implemented by setting the data object referenced by the value property of FormField to a value. Uninstantiation of a FormField sets the data object back to not having a value. This process is well understood by Prolog compiler developers.

When a variable (FormField) is instantiated to a value, the value can not be charged for the life of the activation record (display of the Form containing the FormField). When control flows back to a previous activation record (known in the art of logic programming as “backtracking”), any variables instantiated to values during the life of an activation record, are uninstantiated when the activation record is popped from the run-time control stack. This process is also well understood by Prolog compiler developers.

A displayed Form (activation) represents a Horn clause (a first-order logic rule). And a FormField represents a logic variable in a Horn clause. Thus, the icons on the component palette of an SDT representing instances of the Form and FormField classes are components of a logic programming language. A logic programming language provides the advantage of having a higher level of abstraction (being declarative) that allows for faster software development.

The prior art has icons representing activations and variables. The programming language, VPL (an acronym for Visual Programming in Logic) has a visual component (a box) corresponding to an activation node and a box representing a variable. Likewise, the visual programming language, Prograph.TM. from Pictorius, Inc., has icons representing activations (functions and procedures) and icons representing variables. However, a graphic or icon representing an activation or variable does not also represent a software object that has the properties and methods of GUI component (such as a form or form field) in the generated software application.

The Form icons of this invention represent objects having the properties and methods of GUI form and also represent an activation node in a program. And the FormField icons of this invention represent objects having the properties and methods of GUI form field and also represent a variable in a programming language. The advantage of the dual semantics of an icon is that the step of constructing GUI software and the step of constructing the state-based control flow logic are combined into a single step that shortens development time.

The visual, component-based SDT of this invention provides classes as menu items in the “New . . . ” menu (icons on the palette 501 in FIG. 5), which can be selected to create a subclass. And the subclass can then be added to the component palette of the SDT (for example, 604 in FIG. 6). Thus, this visual, logic programming language is also an object-oriented language, where subclasses are visually created.

This invention makes the each icon representing a Component on the component palette of the visual, component-based SDT a declaration keyword in a visual (iconic), object-oriented, logic programming language. FIG. 6 shows uniquely labeled icons (605, 606, 607 and 608) which represent some of the form field Components in a program.

Each label on the icons is an identifier token specified by the software developer (similar to the software developer specified names for a class, procedure or variable). The preferred embodiment is for each icon label to be the value of the name property of each component. An alternative (and less preferred) embodiment is that each label is the object name in the code generated by the SDT (an object name in Java, C++, and like program). The alternative embodiment would still be required to use the name property inherited from the Component class of each component for name binding.

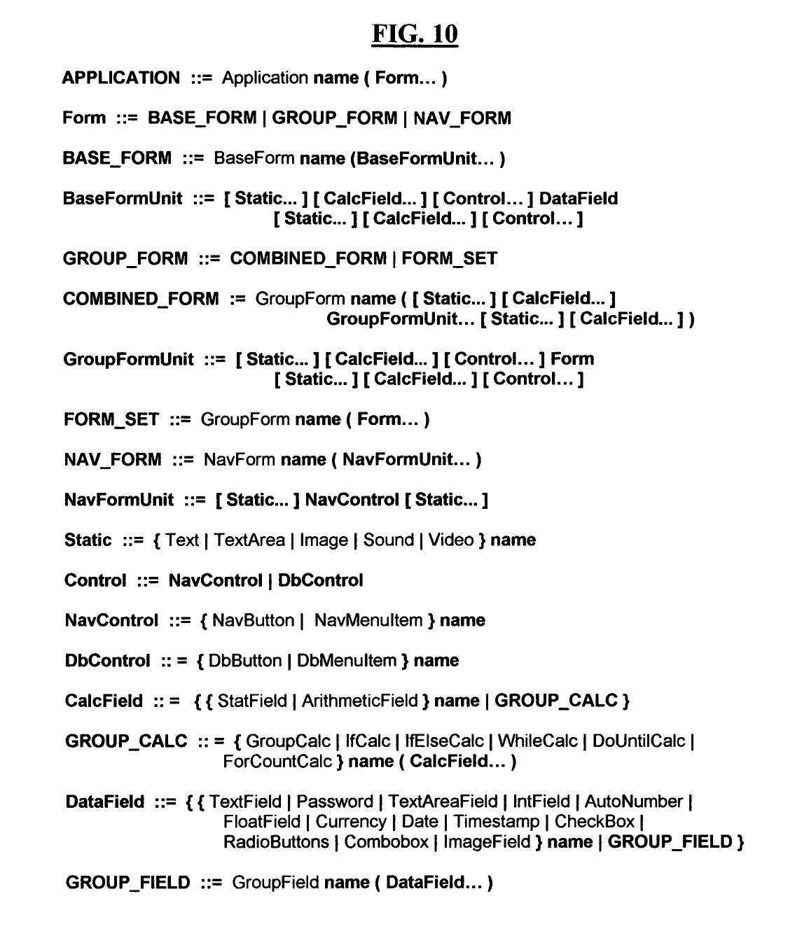

The icons and labels provide the vocabulary of this language. And FIG. 10 shows the context-free grammar, in Backus-Naur Form (BNF), of this language. Each terminal in the BNF shown in FIG. 10 is the name of a concrete subclass of the Component class corresponding to an icon or a Component name (value of the name property). “name” in the BNF is a nonterminal specifying the name of a Component (specified by the name property of a Component).

Symbols and conventions used in the BNF are: brackets, “[ ]”, enclose optional items; braces, “{ }∓, enclose items where only one which is required; a vertical bar, “I”, separates alternatives; an ellipsis, “. . . ”, indicates the preceding syntax element can be repeated; parentheses, “( )”, denote containment of subcomponents; words in bold are place holders (nonterminals) for which a substitute value is defined, words that are not boldface are tokens (terminals).

Syntax checking is done by each subclass of the Container class extending the “add” method. If a software developer attempts to add a Component subclass that violates the grammar rule, then the “add” method uses the prior art of signaling an error (such as throwing an exception) indicating a parse or construction error.

Unlike the prior art of visual, component-based SDTs, where each component has the properties and methods of a GUI component. This invention makes each GUI component a component of programming language that is distinct from the language generated by the SDT (Java, C++, and the like). In the prior art, a Java-based SDT generates Java code, or C++ code, or some other language. In this invention, this visual, object-oriented, logic programming language has its own syntax and semantics.

This invention takes advantage of this code generation capability of the SDT of the prior art to translate the visual, object-oriented, logic program of this invention into a language for which compilers already exist (Java, C++, or the like). This translation process is similar to the first C++ compilers, which translated C++ language programs into a C language program and then used a C compiler to generate assembly language, and an assembler then translated the assembly code into executable code. In this case, the visual (iconic), object-oriented, logic programming language is translated into Java, C++ and like, which a compiler then translates into executable code.

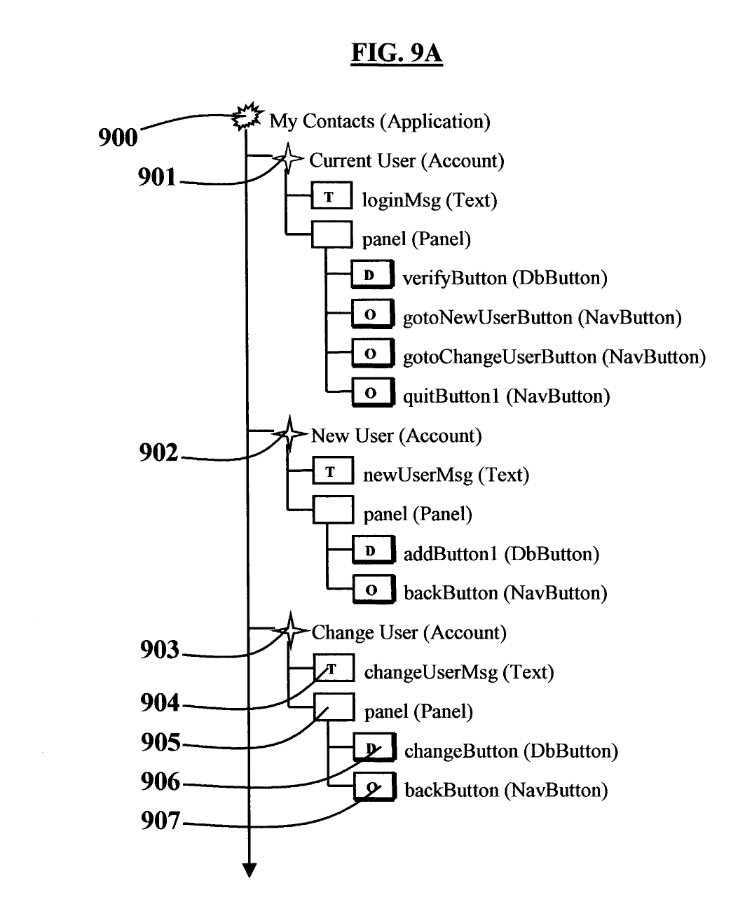

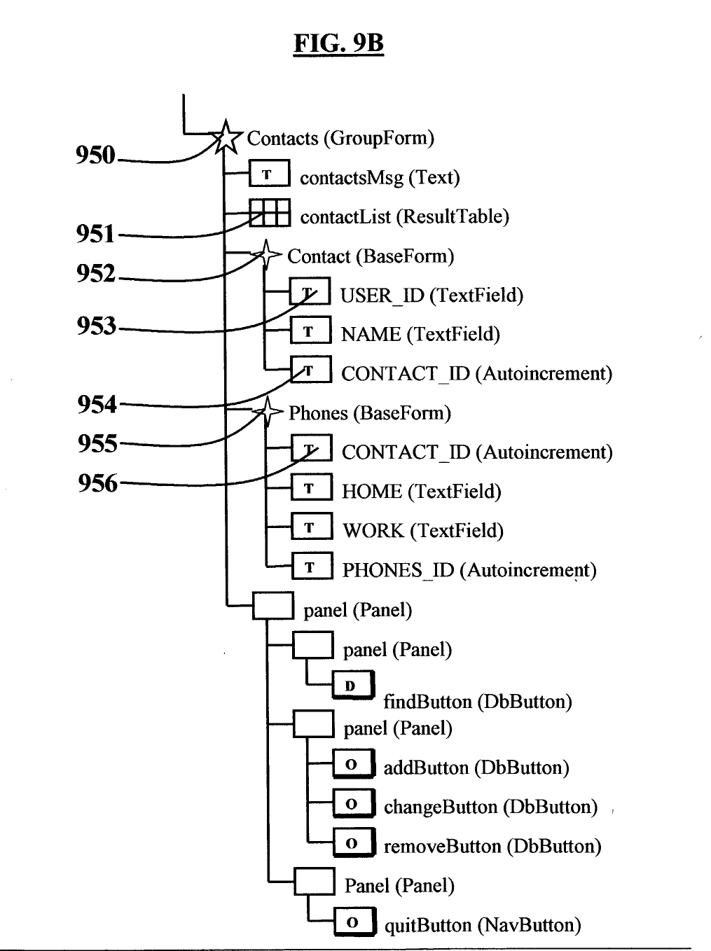

All the components of this invention have been described hereinabove. FIGS. 7, 9A and 9B provide an example of how the components of this invention are used together in practice.

FIGS. 7, 9A and 9B show views of a visual logic program that implements a personal phone book software application, where all the account information, contact names and phone numbers are stored in a relational database. Each user can log into the phone book application with a user name and password, which allows them to access their personal list of “Contacts” and each of their contact's phone numbers and also enter new contacts and phone numbers.

FIG. 7 shows a new subclass of BaseForm, Account 703, being defined. Account 703 has a “USER_NAME” 704, “PASSWORD” 705, and “USER_ID)” 706 fields. FIG. 8 shows the “USER_NAME” field 704 highlighted, which displays the property list editor 707 for the “USER_NAME” field. The “USER_ID” field would have its used_in_form and used_in_table properties set to false and name property set to “USER_ID”. After the properties of Account, “USER_NAME”, “PASSWORD” and “USER_ID” have all their properties set, this new class is compiled and added to the component palette 600 of the SDT shown in FIG. 6 (probably under the “Other” tab of the palette 604 or new tab created by the software developer).

FIG. 9A shows the part of the application with GUI forms handling logging into an account, creating a new account, and changing an account's user name or password. From the “New . . . ” component palette 501 shown in FIG. 5, the Application icon 502 is selected, which creates a new class extending the class, Application. In FIG. 9A this new Application subclass is shown with the name property set to “My Contacts” 900. Next, from the component palette 604 of the SDT shown in FIG. 6, the Account component is selected and added three times to “My Contacts” as shown in FIG. 9B, with the names “Current User” 901, “New User” 902, and “Change User” 903,

To each Account component a Text component is added and its “content” property set specifying the text to display. For example, the changeUserMsg 904 Text component shown in FIG. 9A might have the content property set to “Change your user name or password. Then, click on the Change button.” Each Text component's desired_position property (inherited from the Component class) would be set to “0”, specifying that the text message should appear at the top of the GUI form.

Buttons to perform database operations (DbButton objects) and buttons to navigate to other forms (NavButton objects) can be visually grouped together in a GUI by adding a Panel 905 shown in FIG. 9A. The properties of each button are set. Each DbButton object added to the Account forms have their form_on_success set to “Contacts”. The DbButton object 906 has its “action” property set to “insert”, and its “label” property set to “Add” and the name property set to “changeButton” so that it is obvious looking at the component icon in the containment hierarchy tree what purpose the component serves. Likewise, the NavButton object 907 has its “target_form” property set to “Back” and its “name” property set to “backButton”.

The Account component is a reusable form that wraps a database table. In this case, the Account form was reused three times (“Current User”, “New User”, and “Change User”), each instance of the Account form having its own application specific message and buttons. This kind of reusable form capability does not exist in the prior art.

FIG. 9B, is a continuation of the program in FIG. 9A and shows the definition of a GUI form with form fields corresponding fields from more than one database table. FIG. 9B also demonstrates the use of “context”, where the “USER_ID” field from one of the Account forms shown in FIG. 9A determines which “Contacts” are displayed in the “Contacts” form shown in FIG. 9B.

The GroupForm component, “Contacts” 950 in FIG. 9B, has its combined_layout property set to “true”, which causes the contained forms, Contact 952 and Phone 953 to be displayed a single GUI form. The ResultTable object, contactList 951, will automatically display a table containing a column for each DataField that has its used_in_table property set to “true.” Selecting a row in the ResultTable will cause a “drill down” that displays the associated information in the form fields. The “add” method of the GroupForm will give the added ResultTable a reference to the GroupForm's wrapped table. The method of implementing a query result table and drill down is well understood in the prior art.

Likewise, the “USER_ID” DataField 953 of the “Contacts” form in FIG. 9B and the “USER_ID” DataField 706 of the Account forms shown in FIG. 7 are common columns and both have value properties referencing the same data object. As a consequence, when a person logs into the “Current User” form, the contained “USER_ID” DataField is instantiated to the value associated with the user name and password. This also instantiates the value of “USER_ID” DataField in the “Contacts” DataForm 950 in FIG. 9B, because they are the same variable. Thus, the “Contacts” DataForm 950 will only display “Contacts” with a “USER_II)” field 953 that matches the “USER_ID” associated with the account user name and password. That is, the Account forms set a “context” that is used by the “Contacts” form 950. This mechanism is well understood by Prolog programmers.

The “Contacts” GroupForm 950 does a natural join of the Contact 952 and Phones 955 BaseForms, where “CONTACT ID” 955 (having the name property set to “CONTACT_ID”) within Contact 952 and “CONTACT_ID” 956 (also having the name property set to “CONTACT_ID”) within Phones 955 are common columns. Thus, for each selected row within the contact table, the corresponding row in phones having the same “CONTAC_ID” value will be accessed. This concludes the description of the personal phone book application.

The component-based SDT used in this invention is not required to be objected-oriented (provide class-based inheritance). Methods of translating from object-oriented designs to structured designs is well understood in the prior art. Thus, an SDT such as Microsoft Access, Borland's dBase and the like, which are not object-oriented (because their objects lack inheritance) could be extended to allow software developer-defined components to be added to the component palette.

The choice of inheritance hierarchy of all the subclasses of the Component class described herein is one possible embodiment. Many alternative inheritance hierarchies are possible that achieve the same effect. The classes of this invention can be implemented in any programming language to achieve the same effect. The class names, property names and method names as described herein can be different and still achieve the same effect.

It is also envisioned that a software developer can extend the classes described hereinabove to create new classes using the programming language of the visual, component-based SDT described hereinabove (Java, C++, and the like). For example, if SDT generates Java source code, then the software developer can extend the classes using Java programming to create new classes that can be added to the component palette of the SDT.

Although the present invention has been described in accordance with the embodiments shown, one of ordinary skill in the art will readily recognize that there could be other variations to the embodiments and those variations would be within the spirit and scope of the present invention. Accordingly, many modifications may be made by one of ordinary skill in the art without departing from the spirit and scope of the appended claims.

What is claimed is:

1. A concrete software class comprising the properties and methods to create a graphical user interface (GUI) form and the properties and methods of a relational database base table wrapper, hereinafter referred to as the BaseForm class and an instance of the BaseForm class hereinafter referred to as a BaseForm, further comprising:
a) a vector of references to at least one contained object belonging to a class, hereinafter referred to as the DataField class and an instance of the DataField class referred to as a DataField; said DataField class further comprising the properties and methods to create a GUI field in a GUI form and the properties and methods to wrap a column in a table;
b) a property, hereinafter referred to as the field-properties property, specifying the application specific display properties of one or more said contained DataFields;
c) a property specifying the name of the table wrapped by a BaseForm;
d) a method, hereinafter referred to as the getFieldProperties method, comprising the scan of said vector of references to contained DataFields to obtain the application specific properties of each said referenced DataField and appending said property values to said field-properties property;
e) a method, hereinafter referred to as the setFieldProperties method, comprising the scan of the values in said field-properties property and setting the properties of each corresponding DataField referenced by said vector;
f) a method comprising use of the properties of a BaseForm and properties of said at least one contained DataFields to construct the definition of the table wrapped by a BaseForm;
g) a method comprising: use of said method to construct the definition of the table wrapped by a BaseForm; if a table having the name specified by the table name property of said BaseForm does not exist in a relational database, then this method creates the defined table in the relational database; if said named table exists in the relational database and the definition of said wrapped table does not match the definition of said table definition, then signals a construction error;

2. A method and system of visually specifying the relative display order of each GUI component with respect to other GUI components within a GUI container component comprising:
a) a computer system having a GUI display device;
b) a visual, component-based software development tool (SDT);
c) an abstract software superclass comprising the properties and methods common to all objects that create GUI components, hereinafter referred to as the Component class and an instance of the Component class hereinafter referred to as a Component;
d) a subclass of said Component class, hereinafter referred to as the Container class and an instance of the Container class hereinafter referred to as a Container, comprising the properties and methods for a Container to contain a plurality of other Components;
e) said Component class further comprising a property specifying the relative display order of said Component with respect to other Components within a Container, hereinafter referred to as the desired position property, and said desired position property of a Container having a default value specifying that said added Component be displayed after other Components that have previously been added to said Container;
f) said Container class further comprising a property comprising a vector of Components and comprising a concrete method of adding a Component by inserting said Component into said vector of Components, hereinafter referred to as the add method, where the insertion position within said vector property of a Container is specified by said desired position property of said Component being added to said Container;
g) said Container class is the superclass of all classes having objects that contain other objects;
h) a plurality of concrete instances of said Component class, including a plurality of concrete instances of said Container class, are selectable components on the component palette of said SDT;
i) a software developer uses said SDT to add a Components into a Container and set said desired position property of said added Component;

3. A method and system combining the step of constructing the software of a GUI form and the step of defining a base table in a relational database into a single step, comprising:
a) a computer system having a GUI display device;
b) a visual, component-based SDT;
c) the BaseForm class and DataField class of claim 1; d) a method of visually specifying the relative display position specification added to said SDT;
e) a property editor to facilitate editing said field-properties property of said BaseForm and said field-properties editor added to said SDT;
f) said BaseForm class added to said SDT to be used as an extendable class in said SDT;
g) a BaseForm and an instance of each concrete subclass of said DataField class are added to said SDT to be used as selectable components in said SDT;
h) a method of creating the software of a GUI form and base table wrapper in a software application comprising the steps of a software developer uses said SDT to: add said BaseForm to a container component; set the BaseForm properties; add a plurality of components, including at least one DataField, to said added BaseForm; set the properties of each said added component;
i) a method of creating a reusable GUI form and base table comprising the steps of a software developer uses said SDT to: create a new class extending said BaseForm class; add at least one DataField, to said extended BaseForm class; set the properties of each said added component; and make said extended BaseForm class a selectable component in said SDT;
j) a method of using a reusable GUI form component comprising the steps of a software developer uses said SDT to: add said extended BaseForm component to a container component; edit said field-properties property of said extended BaseForm using said field-properties editor of said SDT; add a add a plurality of components, except DataFields, to said extended BaseForm; visually specify the relative display order of each said added component; set the other properties of each said added component;

4. A method and system combining the step of constructing a composite table field, index and key and the step of constructing the software of GUI form fields into a single step comprising:
a) a computer system having a GUI display device;
b) a visual, component-based SDT;
c) the DataField class of claim 1;
d) a subclass of the DataField class of claim 1, hereinafter referred to as the GroupField class with an instance of the GroupField class referred to as a GroupField, further comprising the properties and methods to contain a plurality of DataFields;
e) objects of all concrete subclasses of the DataField class are selectable components in said SDT, including an object of said GroupField class;
f) said software developer uses said SDT to add a plurality of DataFields into said a GroupField and sets the properties of said GroupField to specify if the contained group of fields comprises: an index; a primary key; a foreign key; set the properties of each said added DataField;

5. A method and system of visual, component-based construction that combines the step of constructing the software that performs a plurality of calculations and the step of constructing the software of GUI form fields displaying at least some of the plurality of calculations into a single step comprising:
a) a computer system having a GUI display device;
b) a visual, component-based SDT;
c) an abstract software class comprising properties and methods to create a GUI form field, hereinafter referred to as the FormField class and an instance of the FormField class hereinafter referred to as a FormField, and said FormField properties comprising: an application specific, Boolean property specifying whether a FonnField creates a field in a GUI form, hereinafter referred to as the used-in-form property; an application specific, Boolean property specifying whether a FormField creates a field in a GUI table, hereinafter referred to as the used-in-table property; and a property referencing an object containing the data displayed in a GUI form field and data entered into a GUI form field, hereinafter referred to as the value property, where the data type contained in said object is determined by either the subclass of said FormField class or a property of a subclass of said FormField;
d) an abstract subclass of said FormField class, hereinafter referred to as the CalcField class and an instance of the CalcField class hereinafter referred to as a CalcField, comprising the properties and abstract methods to perform a calculation, set the object referenced by the value property inherited from FormField class to the result of said calculation;
e) concrete subclasses of the CalcField class have properties specifying the type of calculation and properties specifying the operands of the calculation;
f) a concrete subclass of said CalcField class, hereinafter referred to as the GroupCalc class and an instance of the GroupCalc hereinafter class referred to as a GroupCalc, said GroupCalc is a container of a plurality of other CalcFields and the GroupCalc class frther comprising a plurality of concrete subclasses of the GroupCalc class which perform a set of calculations zero or more times while a condition is satisfied, said condition specified by properties of said GroupCalc;
g) said object referenced by said value property of said GroupCalc references the result of the said contained plurality of CalcFields;
h) objects of all concrete subclasses of the CalcField class are selectable components in said SDT, including said GroupCalc and instances of said subclasses of GroupCalc;
i) a method of adding a plurality of CalcFields to a GroupCalc further comprising the step of setting the used-in-form and used-in-table properties of each said contained CalcField to the Boolean value, false;
j) a software developer uses said SDT to add a plurality of CalcField components to a GroupCalc and sets the properties of each said added CalcField to specify the type of operation and operands;

6. A method and system of creating a reusable calculation comprising:
a) the method and system of claim 6;
b) the GroupCalc class of claim 5 further comprising a property, hereinafter referred to as an arguments property, specifying which FormFields of claim 6 are used as operands of the calculations performed by a plurality of contained CalcFields;
c) a GroupCalc is an extendable class in said SDT;
d) a software developer using said SDT to: extend said GroupCalc class; add a plurality of CalcFields to said extended GroupCalc class; set the properties of each said added CalcField; make said extended GroupCalc class a selectable component in said SDT;

7. A concrete software class comprising the properties and methods to create a GUI form and the properties and methods of a derived relational table wrapper, hereinafter referred to as the GroupForm class and an instance of the GroupForm class hereinafter referred to as a GroupForm, said GroupForm class further comprising:
a) the properties and methods to contain one or more objects, said objects belonging to a class, hereinafter referred to as the Form class and an instance of the Form class hereinafter referred to as a Form; said Form class comprising the properties and methods to create a GUI form and comprising a subclass, hereinafter referred to as the DataForm class and an instance of the DataForm class hereinafter referred to as a DataForm; said DataForm class comprising the properties and methods of the Form class and also comprising the properties and methods of a table wrapper; said GroupForm class being a subclass of the DataForm class;
b) properties and methods to contain a plurality of Forms and must contain at least one Form;
c) said DataForm class further comprising a Boolean property, hereinafter referred to as a uses-context property, where the uses-context property having a Boolean value of true specifies the table wrapped by a DataForm can be used in a relational operation; and the uses-context property having a Boolean value of false specifies the table wrapped by a DataForm can not be used in a relational operation;
d) said table wrapping properties of the DataForm class comprising: a property, hereinafter referred to as a table name property, specifying the name of the table wrapped by a DataForm; a group-relation property, specifying the type of relational operation performed on those tables wrapped by said contained DataForms having a Boolean uses-context property value of true;
e) a table wrapping method of the GroupForm class comprising: a method comprising creation of a table derived from the relation operation, specified by said group-relation property, on those tables wrapped by those contained DataForms having a Boolean uses-context property value of true.

8. A method and system combining the step of constructing the software of a GUI form and the step of defining a derived relational table into a single step, comprising:
a) a computer system having a GUT display device;
b) a visual, component-based SDT;
c) the GroupForm class, Form class, and DataForm class of claim 7;
d) a subclass of said Form class, which creates a GUT form that does not contain any form fields, hereinafter referred to as the NavForm class and an instance of the NavForm class hereinafter referred to as a NavForm;
e) the BaseForm class of claim 1 inheriting the properties and methods of said DataForm class;
f) said NavForm, BaseForm and GroupForm are selectable components in said SDT;
g) a software developer uses said SDT to: add a GroupForm to a container component; set the properties of said added GroupForm; add a plurality of Forms to said added GroupForm; set the properties each said added Form;

9. A method and system combining the step of constructing the software of a GUI form and the step of constructing state-based control flow into a single step, comprising:
a) a computer system having a GUI display device;
b) a visual, component-based SDT further comprising: each selectable component on the component palette of said SDT represents a software object belonging to a superclass, hereinafter referred to as the Component class and each instance of the Component class hereinafter referred to as a Component, said Component class having the properties and methods to create a GUI component; a subclass of the Component class having the properties and methods to contain a plurality other Components, hereinafter referred to as the Container class; a subclass of the Container class having the properties and methods to visually layout contained Components, hereinafter referred to as the Panel class;
c) said Component class further comprising: a name property used by a program to locate a Component by name, said name property assigned a value by a software developer; an abstract display method used by a Component to display itself,
d) said Container class further comprising an extension of said abstract display method inherited from said Component, said method displays itself and send a display message to each contained Component.
e) a visual, object-oriented, logic programming language comprising: each icon representing a selectable component on the component palette of said SDT is a type declaration keyword in said language; the value of the name property of each said component is an identifier in said language; a context-free grammar; and a run-time environment;
f) said run-time environment of said visual, object-oriented, logic programming language further comprising: a run-time control stack, control flow methods, variable declaration scope method, and variable name binding method;
g) a subclass of said Panel class having the properties and methods to create a GUI form, hereinafter referred to as the Form class and an instance of the Form class hereinafter referred to as a Form;
h) each labeled icon representing a Form in the component containment hierarchy of a program is an activation node in the activation tree of said program;
i) said Form class and subclasses of said Form class further comprising: a property referencing said run-time control stack of said visual, object-oriented, logic programming language run-time environment; said control flow methods, variable scope declaration method, and name binding method of said visual, object-oriented, logic programming language run-time environment;
j) a subclass of said Component class, hereinafter referred to as the FormField class and an instance of the FormField class hereinafter referred to as a FormField, comprising properties and methods to create a GUI form field; said FormField class further comprising a property, hereinafter referred to as the value property, which references an object containing a value; each labeled icon corresponding to a FormField in the component-containment hierarchy of a program is a variable declaration in said program, where the value of a variable is the value contained in the object referenced by the value property of the corresponding FormField; said variable is a logic variable;

10. The Form class of claim 9 further comprising:
a) a property, hereinafter referred to as the control stack property, referencing the run-time control stack of the run-time environment of claim 9, said control stack comprising the activation records of the previously displayed Forms traversed to the currently displayed Form, and the activation record of the currently displayed Form is on the top of the control stack;
b) the display method inherited form the Container class further comprising pushing a run-time activation record onto said control stack, where said activation record contains a reference to the Form executing the display method;
c) a method, hereinafter referred to as the build method, that has a parameter referencing said run-time control stack, sets said control stack property of a Form to reference said run-time control stack and sends an initialization message to all Components contained in said Form;
d) an integer property, hereinafter referred to as the form position property, specifying the relative position of a Form with respect to zero or more other Forms within the parent of said Form and said zero or more other Forms;
e) an abstract method, hereinafter referred to as the reset method, which resets the state of a Form referenced by an activation record on top of said runtime control stack back to the state when said Form was first displayed;
f) a method for unwinding the control stack, hereinafter referred to as the unwind method, which uses said reset method and then removes the activation record on top of said control stack;
g) a method for resuming control in a previous activation, hereinafter referred to as the resume method, which uses said reset method and then redisplays the Form referenced by the activation record on top of said control stack without creating a new activation record;
h) a control flow method having a parameter specifying the name of a Form to display, locates and displays said named Form, where said named Form is located and displayed by the steps comprising: said run-time control stack is searched for the named Form, and if an activation record referencing the named Form is found on said run-time control stack, then said unwind method is used repeatedly until said activation record referencing said named Form is on top of said run-time control stack and next, said resume method is used; if an activation record referencing said named Form is not found on said run-time control stack, then: a message is sent to the parent of the currently displayed Form to display said named Form, passing said name as a message parameter; if said parent does not contain said named Form, said parent sends a message to the parent of said parent to display said named Form, passing said name as a message parameter; this process of searching up the container hierarchy repeats until said named Form is located and the located Form is sent a message to display itself; once a Form is displayed, the control flow is determined by user interaction with the GUI controls such as buttons, menu items and the like;
i) a control flow method returning control to a previously displayed Form comprised of using said unwind method and then using the resume method;
j) an abstract subclass, hereinafter referred to as the DataForm class and an instance of the DataForm class hereinafter referred to as a DataForm, comprising: the properties and abstract methods to wrap a relational table; a property, hereinafter referred to as the data_fields property, comprised of a vector of references to at least one contained object belonging to a subclass of the FormField class of claim 9, hereinafter referred to as the DataField class and an instance of the DataField class referred to as a DataField; said DataField class further comprising the properties and methods to wrap a column in a table;
k) said DataForm class further comprising: a Boolean property, hereinafter referred to as a uses-context property, where the uses-context property having a Boolean value of true specifies the DataFields referenced by the data_fields vector property are accessible to the DataForm's parent; and the uses-context property having a Boolean value of false specifies the DataFields referenced by the data_fields vector property are not accessible to the DataForm's parent;
a subclass of said DataForm class, which is a container of a plurality of Forms, hereinafter referred to as the GroupForm class and an instance of the GroupForm class hereinafter referred to as a GroupForm, further comprising: the properties and methods to wrap a table derived from a relational operation; a Boolean property, hereinafter referred to as the combined-layout property;
m) said GroupForm class further comprising a control flow method, said control flow method comprising the steps: if said combined-layout property of a GroupForm has the Boolean value, true, then a single activation record corresponding to the single, combined GUI form is pushed onto the runtime control stack of the language; if the combined-layout property of said GroupForm has the Boolean value, false, then a display message is sent to the first contained Form;
n) said GroupForm class further comprising a scope declaration method, said scope declaration method comprising: a reference to each DataField contained in those contained DataForms having a Boolean uses-context property value of true is appended to the data_fields vector property of a GroupForm, said data_fields property inherited from the DataForm class;
o) said GroupForm class further comprising a variable name binding method, said variable name binding method comprising: setting the value properties of DataFields wrapping common columns to reference a common object, where said DataFields are those DataFields referenced by the inherited data_fields vector property of a GroupForm;
